(19) United States
(12) Patent Application Publication
(10) Pub. No.: US 2013/0059096 A1
(43) Pub. Date: Mar. 7, 2013

(54) METHODS AND COATINGS FOR TREATING BIOFILMS

(71) Applicants: Richard Losick, Lexington, MA (US); Jon Clardy, Jamaica Plain, MA (US); Roberto Kolter, Cambridge, MA (US); Illana Kolodkin-Gal, Cambridge, MA (US); Diego Romero, Boston, MA (US); Shugeng Cao, Waltham, MA (US)

(72) Inventors: Richard Losick, Lexington, MA (US); Jon Clardy, Jamaica Plain, MA (US); Roberto Kolter, Cambridge, MA (US); Illana Kolodkin-Gal, Cambridge, MA (US); Diego Romero, Boston, MA (US); Shugeng Cao, Waltham, MA (US)

(73) Assignee: President and Fellows of Harvard College, Cambridge, MA (US)

(21) Appl. No.: 13/520,753

(22) PCT Filed: Jan. 10, 2011
(86) PCT No.: PCT/US11/20706

§ 371 Date: Nov. 21, 2012

Related U.S. Application Data
(60) Provisional application No. 61/293,414, filed on Jan. 8, 2010.
(60) Provisional application No. 61/329,930, filed on Apr. 30, 2010.

(51) Int. Cl. A01N 37/44; A01N 43/38; A01N 43/36; A01N 59/00; B32B 18/00; A01P 1/00; C09D 7/00; B32B 17/06; B32B 15/04; B32B 9/04; A01N 37/50; A01N 47/44

(52) U.S. Cl. 428/34.1; 514/561; 514/564; 514/565; 514/567; 514/419; 514/563; 514/562; 514/428; 424/600; 106/287.25; 442/123; 428/704; 428/537.5; 428/473; 428/537.1; 428/426; 428/457; 428/688; 428/446

(57) ABSTRACT

A method of treating, reducing, or inhibiting biofilm formation by bacteria, the method comprising: contacting an article with a composition comprising an effective amount of a D-amino acid, said composition being essentially free of the corresponding L-amino acid, thereby treating, reducing or inhibiting formation of the biofilm, wherein the D-amino acid is selected from the group consisting of D-alanine, D-cysteine, D-aspartic acid, D-glutamic acid, D-histidine, D-isoleucine, D-lysine, D-leucine, D-asparagine, D-proline, D-glutamine, D-arginine, D-serine, D-threonine, D-valine, D-tryptophan, D-tyrosine, and a combination thereof.

### PRIORITY

This application claims priority to co-pending U.S. Provisional Application No. 61/293,414, filed Jan. 8, 2010, and U.S. Provisional Application No. 61/329,930, filed Apr. 30, 2010.

The application is related to copending International Patent Application filed on even date herewith and entitled “Method and Composition for Treating Biofilms.”

The contents of those applications are incorporated by reference.

### STATEMENT OF GOVERNMENT RIGHTS

This invention was made with United States Government support under the National Institutes of Health awards CA24487, GM058213, GM082137, GM086258, and GM18568. The United States government has certain rights in the invention.

### BACKGROUND

Biofilms are communities of cells that settle and proliferate on surfaces and are covered by an exopolymer matrix. They are slow-growing and many are in the stationary phase of growth. They can be formed by most, if not all, pathogens. According to the CDC, 65% of all infections in the United States are caused by biofilms that can be formed by common pathogens. Biofilms are also found in industrial settings, such as in drinking water distribution systems.

### SUMMARY

Aspects of the invention feature methods of treating, reducing, or inhibiting biofilm formation by bacteria. In some embodiments, the method comprises contacting a surface with a composition comprising an effective amount of a D-amino acid, thereby treating, reducing or inhibiting formation of the biofilm. In some embodiments, the bacteria are Gram-negative or Gram-positive bacteria. In particular embodiments, the bacteria are Bacillus, Staphylococcus, E. coli, or Pseudomonas bacteria.

In one or more other embodiments, the surface comprises industrial equipment, plumbing systems, bodies of water, household surfaces, textiles and paper.

In other aspects, the invention features compositions, such as industrial, therapeutic or pharmaceutical compositions, comprising one or more D-amino acids. In certain embodiments, the composition comprises D-tyrosine, D-leucine, D-methionine, D-tryptophan, or a combination thereof. In some embodiments, the composition comprises D-tyrosine, D-phenylalanine, D-proline, or a combination thereof. In further embodiments, the composition comprises two or more of D-tyrosine, D-leucine, D-phenylalanine, D-methionine, D-proline, and D-tryptophan, and in yet further embodiments the latter composition is essentially free of detergent and/or L-amino acids. In other embodiments, the composition is used to treat an industrial biofilm described herein, such as in water treatment or plumbing systems.

One aspect of this disclosure is directed to methods of treating, reducing, or inhibiting biofilm formation by a biofilm forming bacteria, the method comprising contacting an article with a composition comprising an effective amount of a D-amino acid or a combination of D-amino acids, thereby treating, reducing or inhibiting formation of the biofilm, wherein the D-amino acid is selected from the group consisting of D-alanine, D-cysteine, D-aspartic acid, D-glutamic acid, D-histidine, D-isoleucine, D-lysine, D-leucine, D-asparagine, D-proline, D-glutamine, D-arginine, D-serine, D-threonine, D-valine, D-tryptophan, D-tyrosine, and a combination thereof, or wherein the combination of D-amino acids is a synergistic combination of two or more D-amino acids selected from the group consisting of D-alanine, D-cysteine, D-aspartic acid, D-glutamic acid, D-phenylalanine, D-histidine, D-isoleucine, D-lysine, D-leucine, D-methionine, D-asparagine, D-proline, D-glutamine, D-arginine, D-serine, D-threonine, D-valine, D-tryptophan, and D-tyrosine.

In some embodiments, the composition is essentially free of the corresponding L-amino acid or L-amino acids relative to the D-amino acids or combination of D-amino acids.

In some embodiments, the article is one or more selected from the group consisting of comprises a industrial equipment, plumbing systems, bodies of water, household surfaces, textiles and paper. In further embodiments, the article is one or more components involved in water condensate collection, water recirculation, sewerage transport, paper pulping and manufacture, and water processing and transport. In still other embodiments, the article is a drain, tub, kitchen appliance, countertop, shower curtain, grout, toilet, industrial food or beverage production facility, floor, boat, pier, oil platform, water intake port, sieve, water pipe, cooling system, or powerplant.

In some embodiments, the article is made from a material selected from the group consisting of metal, metal alloy, synthetic polymer, natural polymer, ceramic, wood, glass, leather, paper, fabric, nom-metallic inorganics, composite materials and combinations thereof.

In other embodiments, contacting comprises applying a coating to the article, said coating comprising an effective amount of the D-amino acid. In further embodiments, the coating further comprises a binder. In some embodiments, the coating is accomplished by wicking, spraying, dipping, spin coating, laminating, painting, screening, extruding or drawing down a coating composition onto the surface. In other embodiments, contacting comprises introducing a D-amino acid into a precursor material and processing the precursor material into the article impregnated with D-amino acid. In further embodiments, contacting comprising introducing a D-amino acid into a liquid composition.

In some embodiments of the foregoing methods, the composition comprises D-tyrosine. In other embodiments, the composition further comprises one or more of D-proline and D-phenylalanine. In still other embodiments, the composition further comprises one or more of D-leucine, D-tryptophan, and D-methionine. In still further embodiments, the composition further comprises one or more of D-alanine, D-cysteine, D-aspartic acid, D-glutamic acid, D-phenylalanine, D-histidine, D-isoleucine, D-lysine, D-leucine, D-methionine, D-asparagine, D-proline, D-glutamine, D-arginine, D-serine, D-threonine, D-valine, D-tryptophan, D-tyrosine.utamic acid, D-phenylalanine, D-histidine, D-isoleucine, D-lysine, D-leucine, D-asparagine, D-proline, D-glutamine, D-arginine, D-serine, D-threonine, D-valine, and D-tryptophan.

In some embodiments of any of the foregoing methods, the methods further comprise contacting the surface with a biocide. In some embodiments, the composition comprises polyhexamethylene biguanide, chlorhexidine, xylitol, triclosan, or chlorine dioxide.

In other embodiments of any of the foregoing methods, the composition contains less than 1% L-amino acids.

In further embodiments of any of the foregoing methods, the composition is essentially free of detergent.

Yet another aspect of this disclosure is directed to coated articles resistant to biofilm formation, comprising an article comprising a coating on at least one exposed surface, the coating comprising an effective amount of a D-amino acid or a combination of D-amino acids, thereby treating, reducing or inhibiting formation of the biofilm, wherein the D-amino acid is selected from the group consisting of D-alanine, D-cysteine, D-aspartic acid, D-glutamic acid, D-histidine, D-isoleucine, D-lysine, D-leucine, D-asparagine, D-proline, D-glutamine, D-arginine, D-serine, D-threonine, D-valine, D-tryptophan, D-tyrosine, and a combination thereof, or wherein the combination of D-amino acids is a synergistic combination of two or more D-amino acids selected from the group consisting of D-alanine, D-cysteine, D-aspartic acid, D-glutamic acid, D-phenylalanine, D-histidine, D-isoleucine, D-lysine, D-leucine, D-methionine, D-asparagine, D-proline, D-glutamine, D-arginine, D-serine, D-threonine, D-valine, D-tryptophan, and D-tyrosine.

In some embodiments, the coating is essentially free of the corresponding L-amino acid or L-amino acids relative to the D-amino acids or combination of D-amino acids.

In some embodiments, the article is one or more selected from the group consisting of comprises a industrial equipment, plumbing systems, bodies of water, household surfaces, textiles and paper. In other embodiments, the article is one or more components involved in water condensate collection, water recirculation, sewerage transport, paper pulping and manufacture, and water processing and transport. In further embodiments, the article is a drain, tub, kitchen appliance, countertop, shower curtain, grout, toilet, industrial food or beverage production facility, floor, boat, pier, oil platform, water intake port, sieve, water pipe, cooling system, or powerplant.

In some embodiments, the article is made from a material selected from the group consisting of metal, metal alloy, synthetic polymer, natural polymer, ceramic, wood, glass, leather, paper, fabric, nom-metallic inorganics, composite materials and combinations thereof. In further embodiments, the coating further comprises a binder. In other embodiments, the coating further comprises a polymer and the D-amino acid is distributed in the polymer.

In some embodiments, the D-amino acid coating is formulated as a slow-release formulation.

In some embodiments, the composition comprises D-tyrosine. In further embodiments, the composition further comprises one or more of D-proline and D-phenylalanine. In still further embodiments, the composition further comprises one or more of D-leucine, D-tryptophan, and D-methionine. In yet other embodiments, the composition further comprises one or more of D-alanine, D-cysteine, D-aspartic acid, D-glutamic acid, D-phenylalanine, D-histidine, D-isoleucine, D-lysine, D-leucine, D-methionine, D-asparagine, D-proline, D-glutamine, D-arginine, D-serine, D-threonine, D-valine, D-tryptophan, D-tyrosine.utamic acid, D-phenylalanine, D-histidine, D-isoleucine, D-lysine, D-leucine, D-asparagine, D-proline, D-glutamine, D-arginine, D-serine, D-threonine, D-valine, and D-tryptophan.

In some embodiments, the composition further comprises a biocide. In further embodiments, the biocide comprises polyhexamethylene biguanide, chlorhexidine, xylitol, triclosan, or chlorine dioxide.

In some embodiments, any of the foregoing coated articles or compositions contains less than 1% L-amino acids. In other embodiments, the coated article or composition is essentially free of detergent.

Another aspect of this disclosure is directed to compositions resistant to biofilm formation, comprising a fluid base; and an effective amount of a D-amino acid or a combination of D-amino acids distributed in the base, thereby treating, reducing or inhibiting formation of the biofilm, wherein the D-amino acid is selected from the group consisting of D-alanine, D-cysteine, D-aspartic acid, D-glutamic acid, D-histidine, D-isoleucine, D-lysine, D-leucine, D-asparagine, D-proline, D-glutamine, D-arginine, D-serine, D-threonine, D-valine, D-tryptophan, D-tyrosine, and a combination thereof, and wherein the combination of D-amino acids is a synergistic combination of two or more D-amino acids selected from the group consisting of D-alanine, D-cysteine, D-aspartic acid, D-glutamic acid, D-phenylalanine, D-histidine, D-isoleucine, D-lysine, D-leucine, D-methionine, D-asparagine, D-proline, D-glutamine, D-arginine, D-serine, D-threonine, D-valine, D-tryptophan, and D-tyrosine.

In some embodiments, the composition is essentially free of the corresponding L-amino acid or L-amino acids relative to the D-amino acids or combination of D-amino acids.

In some embodiments, the fluid base is selected from a liquid, gel, paste.

In some embodiments, the composition is selected from the group consisting of water, washing formulations, disinfecting formulations, paints and coating formulations.

Yet another aspect of this disclosure is directed to coating compositions comprising two or more D-amino acids, wherein at least one D-amino acid is selected from the group consisting of D-tyrosine, D-leucine, D-methionine, and D-tryptophan, and at least one D-amino acid is a different D-amino acid selected from the group consisting of D-cysteine, D-aspartic acid, D-glutamic acid, D-phenylalanine, D-histidine, D-isoleucine, D-lysine, D-leucine, D-methionine, D-asparagine, D-proline, D-glutamine, D-arginine, D-serine, D-threonine, D-valine, D-tryptophan, and D-tyrosine, and a polymeric binder.

In some embodiments, the composition is essentially free of the corresponding L-amino acid relative to the D-amino acid.

### BRIEF DESCRIPTION OF THE FIGURES

The following figures are presented for the purpose of illustration only, and are not intended to be limiting.

FIGS. 1A and 1B show cells of B. subtilis strain NCIB3610 that were grown at 22° C. in 12-well plates in liquid biofilm-inducing medium for 3 days (A) or for 8 days (B).

FIGS. 1C and 1D show cells grown for 3 days in medium to which had been added a dried and resuspended methanol eluate (1:100 v/v) from a C18 Sep Pak column that had been loaded with conditioned medium from a 6-8 day-old culture (C) or a 3 day-old culture (D). The final concentration of concentrated factor added to the wells represented a 1:4 dilution on a volume basis of the original conditioned media.

FIG. 1E is the same as FIG. 1C except the factor was further purified on the C-18 column by step-wise elution with methanol. Shown is the result of adding 3 μl of the 40% methanol eluate.

FIG. 1F is the same as FIG. 1C except that prior to addition to fresh medium the 40% methanol eluate was incubated with Proteinase K beads for 2 hours followed by centrifugation to remove the beads.

FIG. 2A shows the effects on pellicle formation of adding D-tyrosine (3 μM), D-leucine (8.5 mM), L-tyrosine (7 mM), or L-leucine (8.5 mM) to freshly inoculated cultures in biofilm-inducing medium after incubation for 3 days.

FIG. 2B shows the Minimal Biofilm Inhibitory Concentration (MBIC) of D-amino acids required for complete inhibition of pellicle formation.

FIG. 2C shows 3 day-old cultures to which had been added no amino acids (untreated), D-tyrosine (3 μM) or a mixture of D-tyrosine, D-tryptophan, D-methionine and D-leucine (2.5 nM each), followed by further incubation for 8 hours.

FIG. 2D shows the effect of concentrated Sep Pak C-18 column eluate from conditioned medium from an 8-day-old culture from the wild type or from a strain (IKG55) doubly mutant for ylmE and racX.

FIG. 2E shows S. aureus (strain SCO1) that had been grown in 12-well polystyrene plates for 24 hours at 37° C. in TSB medium containing glucose (0.5%) and NaCl (3%). Additionally added to the wells were no amino acids (untreated), D-tyrosine (50 μM) or the D-amino acid mixture (15 nM each). Cells bound to the polystyrene were visualized by washing away unbound cells and then staining with crystal violet.

FIG. 3A shows incorporation of radioactive D-tyrosine into the cell wall. Cells were grown in biofilm-inducing medium and incubated with either ¹⁴C-D-tyrosine or ¹⁴C-L-proline (10 μCi/ml) for 2 h at 37° C. Results are presented as a percent of total incorporation into cells (360,000 cpm/ml for L-proline and 46,000 cpm/ml for D-tyrosine).

FIG. 3B shows total fluorescence from cells (DR-30 (Romero et al., Proc. Natl. Acad. Sci. USA (2010, in press)) containing a functional tasA-mCherry translational fusion. The cells were grown to stationary phase with shaking in biofilm-inducing medium in the presence or absence of D-tyrosine (6 μM).

FIG. 3C shows cell association of TasA-mCherry by fluorescence microscopy. Wild-type cells and yqxM6 (IKG51) mutant cells containing the tasA-mCherry fusion were grown to stationary phase (OD=1.5) with shaking in biofilm-inducing medium in the presence or absence (untreated) of D-tyrosine (6 μM) as indicated, washed in PBS, and visualized by fluorescence microscopy.

FIG. 3D shows cell association of TasA fibers by electron microscopy. 24-hour-old cultures were incubated without (images 1 and 2) or with (images 3-6) D-tyrosine (0.1 mM) for an additional 12 hours. TasA fibers were stained by immunogold labeling using anti-TasA antibodies, and visualized by transmission electron microscopy as described in the Examples. The cells were mutant for the eps operon (Δeps) as the absence of exopolysaccharide significantly improves the imaging of TasA fibers. Filled arrows indicate fiber bundles; open arrows indicate individual fibers. The scale bar is 500 nm. The scale bar in the enlargements of images 2, 4 and 6 is 100 nm. Images 1 and 2 show fiber bundles attached to cells, images 3, 4 and 6 show individual fibers and bundles detached from cells, and images 3-5 show cells with little or no fiber material.

FIG. 4A shows cells grown for 3 days on solid (top images) or liquid (bottom images) biofilm-inducing medium that did or did not contain D-tyrosine.

FIG. 4B shows an abbreviated amino acid sequence for YqxM. Underlined are residues specified by codons in which the yqxM2 and yqxM6 frame-shift mutations resulted in the indicated sequence changes.

FIG. 5 shows wells containing MSgg medium supplemented with D-tryptophan (0.5 mM), D-methionine (2 mM), L-tryptophan (5 mM) or L-methionine (5 mM) that were inoculated with strain NCIB3610 and incubated for 3 days.

FIG. 6 shows plates containing solid MSgg medium supplemented with D-tyrosine (3 μM) or D-leucine (8.5 mM) that were inoculated with strain NCIB3610 and incubated for 4 days.

FIG. 7 shows NCIB3610 (WT) and a mutant doubly deleted for ylmE and racX (IKG155) that were grown in 12 well plates and incubated for 5 days.

FIG. 8 shows the effect of D-amino acids on cell growth. Cells were grown in MSgg medium containing D-tyrosine (3 μM), D-leucine (8.5 mM) or the four D-amino acids mixture (2.5 nM each) with shaking.

FIG. 9A shows the expression of P_{yqxM}-lacZ by strain FC122 (carrying P_{yqxM}-lacZ) and FIG. 9B shows the expression of P_{epsA}-lacZ by strain FC5 (carrying P_{epsA}-lacZ) that were grown in MSgg medium containing D-tyrosine (3 μM), D-leucine (8.5 mM) or the four D-amino acids mixture (2.5 nM each) with shaking.

FIG. 10 shows the inhibition of Pseudomonas aeruginosa biofilm formation by D-amino acids. P. aeruginosa strain P014 was grown in 12-well polystyrene plates for 48 hours at 30° C. in M63 medium containing glycerol (0.2%) and Casamino acids (20 μg/ml). Additionally added to the wells were no amino acids (untreated), D-tyrosine or the D-amino acid mixture. Cells bound to the polystyrene were visualized by washing away unbound cells and then staining with crystal violet. Wells were stained with 500 μl of 1.0% Crystal-violet dye, rinsed twice with 2 ml double-distilled water and thoroughly dried.

FIG. 11 shows crystal violet staining of Staphylococcus aureus biofilms grown with either individual D-amino acids or the quartet mixture in TSB medium for 24 hrs.

FIG. 12 shows crystal violet staining of Pseudomonas aeruginosa grown with either individual D-amino acids or the quartet mixture in M63 medium for 48 hrs.

FIG. 13 shows crystal violet staining of Staphylococcus aureus biofilms grown with either individual D-amino acids or a mixture in TSB medium for 24 hrs.

FIG. 14 shows crystal violet staining of Staphylococcus aureus biofilms grown in TSB medium with L-amino acids for 24 hrs.

FIG. 15 is a representative image of the Staphylococcus aureus biofilms formed in TSB medium applied with D-amino acids after removing planktonic bacteria.

FIG. 16 is a representative image of the Staphylococcus aureus biofilms formed in TSB medium applied with L-amino acids after removing planktonic bacteria.

FIG. 17 is a quantification of the cells within the Staphylococcus aureus biofilms formed in TSB medium after removing planktonic bacteria. Cells were re-suspended in PBS.

FIG. 18 shows the effect of D-aa mixture (1 mM) on Staphylococcus aureus biofilm formation on surfaces. Epoxy surfaces were soaked in D/L aa mixture and then incubated with bacteria for 24 hrs.

FIG. 19 shows the effect of D-aa mixture (1 mM) on Staphylococcus aureus biofilm formation on surfaces. Epoxy surfaces were soaked in D/L aa mixture and then incubated with bacteria for 24 hrs.

FIG. 20 shows the effect of D-aa on biofilm formation on M63 solid medium in Pseudomonas aeruginosa. Colonies were grown on room temperature for 4 days.

FIG. 21 shows the Sytox-staining of single attached cells in the button of 6 well plate of Pseudomonas aeruginosa in biofilm inducing conditions.

FIG. 22 shows crystal violet staining of Proteus mirabilis grown with either D-amino acids (100 μM) or the L-amino acids (100 μM) mixture in LB medium for 48 hrs.

FIG. 23 shows crystal violet staining of Streptococcus mutans grown either with D- or L-amino acids (1 mM) in BHI medium applied with sucrose (0.5%) medium for 72 hrs.

### DETAILED DESCRIPTION

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The terms “prevent,” “preventing,” and “prevention” refer herein to the inhibition of the development or onset of a biofilm or the prevention of the recurrence, onset, or development of one or more indications or symptoms of a biofilm on a surface resulting from the administration of a composition described herein (e.g., a prophylactic or therapeutic composition), or the administration of a combination of therapies (e.g., a combination of prophylactic or therapeutic compositions).

Other features and advantages of the invention will be apparent from the following detailed description, and from the claims. As will be apparent to one of skill in the art, specific features and embodiments described herein can be combined with any other feature or embodiment.

The invention is based, at least in part, on the discovery that D-amino acids present in conditioned medium from mature biofilms prevents biofilm formation and triggers the disassembly of existing biofilms. Standard amino acids can exist in either of two optical isomers, called L- or D-amino acids, which are mirror images of each other. While L-amino acids represent the vast majority of amino acids found in proteins, D-amino acids are components of the peptidoglycan cell walls of bacteria. The D-amino acids described herein are capable of penetrating biofilms on living and non-living surfaces, of preventing the adhesion of bacteria to surfaces and any further build-up of the biofilm, of detaching such biofilm and/or inhibiting the further growth of the biofilm-forming micro-organisms in the biological matrix, or of killing such micro-organisms.

D-amino acids are known in the art and can be prepared using known techniques. Exemplary methods include, e.g., those described in U.S. Publ. No. 20090203091. D-amino acids are also commercially available (e.g., from Sigma Chemicals, St. Louis, Mo.).

Any D-amino acid can be used in the methods described herein, including without limitation D-alanine, D-cysteine, D-aspartic acid, D-glutamic acid, D-phenylalanine, D-histidine, D-isoleucine, D-lysine, D-leucine, D-methionine, D-asparagine, D-proline, D-glutamine, D-arginine, D-serine, D-threonine, D-valine, D-tryptophan, or D-tyrosine. A D-amino acid can be used alone or in combination with other D-amino acids. In exemplary methods, 2, 3, 4, 5, 6, or more D-amino acids are used in combination. Preferably, D-tyrosine, D-leucine, D-methionine, or D-tryptophan, either alone or in combination, are used in the methods described herein. In other preferred embodiments, D-tyrosine, D-proline and D-phenylalanine, either alone or in combination, are used in the methods described herein

A D-amino acid can be used at a concentration of about 0.1 nM to about 100 μM, e.g., about 1 nM to about 10 μM, about 5 nM to about 5 μM, or about 10 nM to about 1 μM, for example, at a concentration of 0.1 nM to 100 μM, 1 nM to 10 μM, 5 nM to 5 μM, or 10 nM to 1 μM.

An exemplary D-amino acid composition, coating or solution found to be particularly effective in inhibiting or treating biofilm formation includes D-tyrosine. In some embodiments, D-tyrosine is used alone and can be used, for example, as concentrations of less than 1 mM, or less than 100 μM or less than 10 μM, or at a concentration of 0.1 nM to 100 μM, e.g., 1 nM to 10 μM, 5 nM to 5 μM, or 10 nM to 1 μM.

In other embodiments, D-tyrosine is used in combination with one or more of D-proline and D-phenylalanine. In some embodiments, D-tyrosine is used in combination with one or more of D-leucine, D-tryptophan, and D-methionine. The combinations of D-tyrosine with one or more of D-proline, D-phenylalanine, D-leucine, D-tryptophan, and D-methionine can be synergistic and can be effective in inhibiting or treating biofilm formation at total D-amino acid concentrations of 10 μM or less, e.g., about 1 nM to about 10 μM, about 5 nM to about 5 μM, or about 10 nM to about 1 μM, or at a concentration of 0.1 nM to 100 μM, e.g., 1 nM to 10 μM, 5 nM to 5 μM, or 10 nM to 1 μM.

In some embodiments, the combinations of D-amino acids are equimolar. In other embodiments, the combinations of D-amino acids are not in equimolar amounts.

In some embodiments, the composition is essentially free of L-amino acids. For example, the composition comprises less than about 30%, less than about 20%, less than about 10%, less than about 5%, less than about 1%, less than about 0.5%, less than about 0.25%, less than about 0.1%, less than about 0.05%, less than about 0.025%, less than about 0.01%, less than about 0.005%, less than about 0.0025%, less than about 0.001%, or less, of L-amino acids. In other embodiments, the composition comprises less than 30%, less than 20%, less than 10%, less than 5%, less than 1%, less than 0.5%, less than 0.25%, less than 0.1%, less than 0.05%, less than 0.025%, less than 0.01%, less than 0.005%, less than 0.0025%, less than 0.001% of L-amino acids. In preferred embodiments, the percentage of L-amino acid is relative to the corresponding D-amino acid. By way of example, a racemic mixture of L-amino acid and D-amino acid contains 50% L-amino acid.

In some embodiments, the composition is essentially free of detergent. For example, the composition comprises, less than about 30 wt %, less than about 20 wt %, less than about 10 wt %, less than about 5 wt %, less than about 1 wt %, less than about 0.5 wt %, less than about 0.25 wt %, less than about 0.1 wt %, less than about 0.05 wt %, less than about 0.025 wt %, less than about 0.01 wt %, less than about 0.005 wt %, less than about 0.0025 wt %, less than about 0.001 wt %, or less, of a detergent. In other embodiments, the composition comprises, relative to the overall composition, less than about 30 wt %, less than 20 wt %, less than 10 wt %, less than 5 wt %, less than 1 wt %, less than 0.5 wt %, less than 0.25 wt %, less than 0.1 wt %, less than 0.05 wt %, less than 0.025 wt %, less than 0.01 wt %, less than 0.005 wt %, less than 0.0025 wt %, less than 0.001 wt % of a detergent. Many times in formulations containing detergents, e.g., surfactants, the surfactant will interact with the active agent, ere the D-amino acid, which could greatly affect the agent's efficacy. In some embodiments, it can be necessary to screen agents effectiveness relative to anionic surfactants, cationic surfactants, non-ionic surfactants and zwitter ionic surfactants as a screening to determine if the presence of the surfactant type alters the efficacy. Reducing or eliminating detergents, can increase the efficacy of the compositions and/or reduce formulation complications.

### Biofilms

Most bacteria can form complex, matrix-containing multicellular communities known as biofilms (O'Toole et al., Annu Rev. Microbiol. 54:49 (2000); López et al., FEMS Microbiol. Rev. 33:152 (2009); Karatan et al., Microbiol. Mol. Biol. Rev. 73:310 (2009)). Biofilm-associated bacteria are protected from environmental insults, such as antibiotics (Bryers, Biotechnol. Bioeng. 100:1 (2008)). However, as biofilms age, nutrients become limiting, waste products accumulate, and it is advantageous for the biofilm-associated bacteria to return to a planktonic existence (Karatan et al., Microbiol. Mol. Biol. Rev. 73:310 (2009)). Thus, biofilms have a finite lifetime, characterized by eventual disassembly.

Biofilms are understood, very generally, to be aggregations of living and dead micro-organisms, especially bacteria, that adhere to living and non-living surfaces, together with their metabolites in the form of extracellular polymeric substances (EPS matrix), e.g. polysaccharides. The activity of antibiofilm substances that normally exhibit a pronounced growth-inhibiting or lethal action with respect to planktonic cells may be greatly reduced with respect to microorganisms that are organized in biofilms, for example because of inadequate penetration of the active substance into the biological matrix.

Gram-negative bacteria and Gram-positive bacteria, in addition to other unicellular organisms, can produce biofilms. Bacterial biofilms are surface-attached communities of cells that are encased within an extracellular polysaccharide matrix produced by the colonizing cells. Biofilm development occurs by a series of programmed steps, which include initial attachment to a surface, formation of three-dimensional microcolonies, and the subsequent development of a mature biofilm. The more deeply a cell is located within a biofilm (such as, the closer the cell is to the solid surface to which the biofilm is attached to, thus being more shielded and protected by the bulk of the biofilm matrix), the more metabolically inactive the cells are. The consequences of this physiologic variation and gradient create a collection of bacterial communities where there is an efficient system established whereby microorganisms have diverse functional traits. A biofilm also is made up of various and diverse non-cellular components and can include, but are not limited to carbohydrates (simple and complex), lipids, proteins (including polypeptides), and lipid complexes of sugars and proteins (lipopolysaccharides and lipoproteins).

The biofilm can allow bacteria to exist in a dormant state for a certain amount of time until suitable growth conditions arise thus offering the microorganism a selective advantage to ensure its survival. However, this selection can pose serious threats to human health in that biofilms have been observed to be involved in about 65% of human bacterial infections (Smith, Adv. Drug Deliv. Rev. 57:1539-1550 (2005); Hall-Stoodley et al., Nat. Rev. Microbiol. 2:95-108 (2004)).

Biofilms can also affect a wide variety of biological, medical, commercial, industrial, and processing operations, as described herein. In industrial settings, biofilms can adhere to surfaces, such as pipes and filters. Biofilms are problematic in industrial settings because they cause biocorrosion and biofouling in industrial systems, such as heat exchangers, oil pipelines, water systems, filters, and the like (Coetser et al., (2005) Crit. Rev. Micro. 31: 212-32). Thus, biofilms can inhibit fluid flow-through in pipes, clog water and other fluid systems, as well as serve as reservoirs for pathogenic bacteria, protozoa, and fungi. As such, industrial biofilms are an important cause of economic inefficiency in industrial processing systems. Further, different species of biofilm-producing bacteria may coexist within such system. Thus, there exists in such systems the potential of biofilm formation due to multiple species.

The methods and materials described herein can prevent or reduce biofilm formation associated with a wide variety of commercial, industrial, and processing operations, such as those found in water handling/processing industries. In some instances, a D-amino acid can be applied to a biofilm found on such surfaces. In other instances, a D-amino acid can be utilized to prevent biofilm-forming bacteria from adhering to surfaces. For example, the surface can be a surface on industrial equipment (such as equipment located in Good Manufacturing Practice (GMP) facilities, food processing plants, photo processing venues, and the like), the surfaces of plumbing systems, or the surfaces bodies of water (such as lakes, swimming pools, oceans, and the like).

The surfaces can be coated, sprayed, or impregnated with a D-amino acid prior to use to prevent the formation of bacterial biofilms. Specific nonlimiting examples of such surfaces include plumbing, tubing, and support components involved with water condensate collections, sewerage discharges, paper pulping operations, re-circulating water systems (such as air conditioning systems, a cooling tower, and the like), and, in water bearing, handling, processing, and collection systems. Adding a D-amino acid can treat, prevent or reduce formation of biofilms on the surface of the water or on the surface of pipes or plumbing of water-handling systems, or other surfaces involved in the collection and/or operation systems that the water contacts.

### Biofilm-Forming Bacteria

The methods described herein can be used to prevent or delay the formation of, and/or treat, biofilms. In exemplary methods, the biofilms are formed by biofilm-forming bacteria. The bacteria can be a gram negative bacterial species or a gram positive bacterial species. Nonlimiting examples of such bacteria include a member of the genus Actinobacillus (such as Actinobacillus actinomycetemcomitans), a member of the genus Acinetobacter (such as Acinetobacter baumannii), a member of the genus Aeromonas, a member of the genus Bordetella (such as Bordetella pertussis, Bordetella bronchiseptica, or Bordetella parapertussis), a member of the genus Brevibacillus, a member of the genus Brucella, a member of the genus Bacteroides (such as Bacteroides fragilis), a member of the genus Burkholderia (such as Burkholderia cepacia or Burkholderia pseudomallei), a member of the genus Borelia (such as Borelia burgdorferi), a member of the genus Bacillus (such as Bacillus anthracis or Bacillus subtilis), a member of the genus Campylobacter (such as Campylobacter jejuni), a member of the genus Capnocytophaga, a member of the genus Cardiobacterium (such as Cardiobacterium hominis), a member of the genus Citrobacter, a member of the genus Clostridium (such as Clostridium tetani or Clostridium difficile), a member of the genus Chlamydia (such as Chlamydia trachomatis, Chlamydia pneumoniae, or Chlamydia psiffaci), a member of the genus Eikenella (such as Eikenella corrodens), a member of the genus Enterobacter, a member of the genus Escherichia (such as Escherichia coli), a member of the genus Francisella (such as Francisella tularensis), a member of the genus Fusobacterium, a member of the genus Flavobacterium, a member of the genus Haemophilus (such as Haemophilus ducreyi or Haemophilus influenzae), a member of the genus Helicobacter (such as Helicobacter pylori), a member of the genus Kingella (such as Kingella kingae), a member of the genus Klebsiella (such as Klebsiella pneumoniae), a member of the genus Legionella (such as Legionella pneumophila), a member of the genus Listeria (such as Listeria monocytogenes), a member of the genus Leptospirae, a member of the genus Moraxella (such as Moraxella catarrhalis), a member of the genus Morganella, a member of the genus Mycoplasma (such as Mycoplasma hominis or Mycoplasma pneumoniae), a member of the genus Mycobacterium (such as Mycobacterium tuberculosis or Mycobacterium leprae), a member of the genus Neisseria (such as Neisseria gonorrhoeae or Neisseria meningitidis), a member of the genus Pasteurella (such as Pasteurella multocida), a member of the genus Proteus (such as Proteus vulgaris or Proteus mirablis), a member of the genus Prevotella, a member of the genus Plesiomonas (such as Plesiomonas shigelloides), a member of the genus Pseudomonas (such as Pseudomonas aeruginosa), a member of the genus Providencia, a member of the genus Rickettsia (such as Rickettsia rickettsii or Rickettsia typhi), a member of the genus Stenotrophomonas (such as Stenotrophomonas maltophila), a member of the genus Staphylococcus (such as Staphylococcus aureus or Staphylococcus epidermidis), a member of the genus Streptococcus (such as Streptococcus viridans, Streptococcus pyogenes (group A), Streptococcus agalactiae (group B), Streptococcus bovis, or Streptococcus pneumoniae), a member of the genus Streptomyces (such as Streptomyces hygroscopicus), a member of the genus Salmonella (such as Salmonella enteriditis, Salmonella typhi, or Salmonella typhimurium), a member of the genus Serratia (such as Serratia marcescens), a member of the genus Shigella, a member of the genus Spirillum (such as Spirillum minus), a member of the genus Treponema (such as Treponema pallidum), a member of the genus Veillonella, a member of the genus Vibrio (such as Vibrio cholerae, Vibrio parahaemolyticus, or Vibrio vulnificus), a member of the genus Yersinia (such as Yersinia enterocolitica, Yersinia pestis, or Yersinia pseudotuberculosis), and a member of the genus Xanthomonas (such as Xanthomonas maltophilia).

Specifically, Bacillus subtilis forms architecturally complex communities on semi-solid surfaces and thick pellicles at the air/liquid interface of standing cultures (López et al., FEMS Microbiol. Rev. 33:152 (2009); Aguilar et al., Curr. Opin. Microbiol. 10:638 (2007); Vlamakis et al., Genes Dev. 22:945 (2008); Branda et al., Proc. Natl. Acad. Sci. USA 98:11621 (2001)). B. subtilis biofilms consist of long chains of cells held together by an extracellular matrix consisting of an exopolysaccharide and amyloid fibers composed of the protein TasA (Branda et al., Proc. Natl. Acad. Sci. USA 98:11621 (2001); Branda et al., Mol. Microbiol. 59:1229 (2006); Romero et al., Proc. Natl. Acad. Sci. USA (2010, in press)). The exopolysaccharide is produced by enzymes encoded by the epsA-O operon (“eps operon”) and the TasA protein is encoded by the promoter-distal gene of the yqxM-sipW-tasA operon (“yqxM operon”) (Chu et al., Mol. Microbiol. 59:1216 (2006)).

Biofilm-producing bacteria, e.g., a species described herein, can be found in a live subject, in vitro, or on a surface, as described herein.

### Applications/Formulations

D-amino acid compositions can be used to reduce or prevent biofilm formation on non-biological semi-solid or solid surfaces. Such a surface can be any surface that may be prone to biofilm formation and adhesion of bacteria. Nonlimiting examples of surfaces include hard surfaces made from one or more of the following materials: metal, plastic, rubber, board, glass, wood, paper, concrete, rock, marble, gypsum and ceramic materials, such as porcelain, which optionally are coated, for example, with paint or enamel.

In certain embodiments, the surface is a surface that contacts with water or, in particular, with standing water. For example, the surface can be a surface of a plumbing system, industrial equipment, water condensate collectors, equipment used for sewer transport, water recirculation, paper pulping, and water processing and transport. Nonlimiting examples include surfaces of drains, tubs, kitchen appliances, countertops, shower curtains, grout, toilets, industrial food and beverage production facilities, and flooring. Other surfaces include marine structures, such as boats, piers, oil platforms, water intake ports, sieves, and viewing ports.

A D-amino acid can be applied to a surface by any known means, such as by covering, coating, contacting, associating with, filling, or loading the surface with an effective amount of a D-amino acid. The D-amino acid can be applied to the surface with a suitable carrier, e.g., a fluid carrier, that is removed, e.g., by evaporation, to leave a D-amino acid coating. In specific examples, a D-amino acid is directly affixing to a surface by either spraying the surface, for example with a polymer/D-amino acid film, by dipping the surface into or spin-coating onto the surface, for example with a polymer/D-amino acid solution, or by other covalent or noncovalent means. In other instances, the surface is coated with an absorbant substance (such as a hydrogel) that absorbs the D-amino acid.

The D-amino acids are suitable for treating surfaces in a hospital or medical setting. Application of the D-amino acids and compositions described herein can inhibit biofilm formation or reduce biofilm formation when applied as a coating, lubricant, washing or cleaning solution, etc.

The D-amino acids described herein are also suitable for treating, especially preserving, textile fibre materials. Such materials are undyed and dyed or printed fibre materials, e.g. of silk, wool, polyamide or polyurethanes, and especially cellulosic fibre materials of all kinds. Such fibre materials are, for example, natural cellulose fibres, such as cotton, linen, jute and hemp, as well as cellulose and regenerated cellulose. Paper, for example paper used for hygiene purposes, may also be provided with antibiofilm properties using one or more D-amino acids described herein. It is also possible for nonwovens, e.g. nappies/diapers, sanitary towels, panty liners, and cloths for hygiene and household uses, to be provided with antibiofilm properties.

The D-amino acids described herein are suitable also for treating, especially imparting antibiofilm properties to or preserving industrial formulations such as coatings, lubricants etc.

The D-amino acids described herein can also be used in washing and cleaning formulations, e.g. in liquid or powder washing agents or softeners. The D-amino acids described herein can also be used in household and general-purpose cleaners for cleaning and disinfecting hard surfaces. An exemplary cleaning preparation has, for example, the following composition: 0.01 to 5% by weight of one or more D-amino acids, 3.0% by weight octyl alcohol 4EO, 1.3% by weight fatty alcohol C₈-C₁₀ polyglucoside, 3.0% by weight isopropanol, and water ad 100%.

The D-amino acids described herein can also be used for the antibiofilm treatment of wood and for the antibiofilm treatment of leather, the preserving of leather and the provision of leather with antibiofilm properties. The D-amino acids described herein can also be used for the protection of cosmetic products and household products from microbial damage.

The D-amino acids described herein are useful in preventing bio-fouling, or eliminating or controlling microbe accumulation on the surfaces either by incorporating one or more D-amino acids described herein into the article or surface of the article in question or by applying the antibiofilm to these surfaces as part of a coating or film. Such surfaces include surfaces in contact with marine environments (including fresh water, brackish water and salt water environments), for example, the hulls of ships, surfaces of docks or the inside of pipes in circulating or pass-through water systems. Other surfaces are susceptible to similar biofouling, for example walls exposed to rain water, walls of showers, roofs, gutters, pool areas, saunas, floors and walls exposed to damp environs such as basements or garages and even the housing of tools and outdoor furniture. U.S. Pat. No. 7,618,697, which is hereby incorporated in its entirety by reference, discloses compounds useful in coatings or films in protecting surfaces from bio-fouling.

When applied as a part of a film or coating, one or more D-amino acid described herein can be part of a composition which also comprises a binder. The binder may be any polymer or oligomer compatible with the present antibiofilms. The binder may be in the form of a polymer or oligomer prior to preparation of the anti-fouling composition, or may form by polymerization during or after preparation, including after application to the substrate. In certain applications, such as certain coating applications, it will be desirable to crosslink the oligomer or polymer of the anti fouling composition after application. The term “binder” as used herein also includes materials such as glycols, oils, waxes and surfactants commercially used in the care of wood, plastic, glass and other surfaces. Examples include water proofing materials for wood, vinyl protectants, protective waxes and the like.

The composition can be a coating or a film. When the composition is a thermoplastic film which is applied to a surface, for example, by the use of an adhesive or by melt applications including calendaring and co-extrusion, the binder is the thermoplastic polymer matrix used to prepare the film. When the composition is a coating, it may be applied as a liquid solution or suspension, a paste, gel, oil or the coating composition may be a solid, for example a powder coating which is subsequently cured by heat, UV light or other method.

As the composition of the invention may be a coating or a film, the binder can be comprised of any polymer used in coating formulations or film preparation. For example, the binder is a thermoset, thermoplastic, elastomeric, inherently crosslinked or crosslinked polymer. Thermoset, thermoplastic, elastomeric, inherently crosslinked or crosslinked polymers include polyolefin, polyamide, polyurethane, polyacrylate, polyacrylamide, polycarbonate, polystyrene, polyvinyl acetates, polyvinyl alcohols, polyester, halogenated vinyl polymers such as PVC, natural and synthetic rubbers, alkyd resins, epoxy resins, unsaturated polyesters, unsaturated polyamides, polyimides, silicon containing and carbamate polymers, fluorinated polymers, crosslinkable acrylic resins derived from substituted acrylic esters, e.g. from epoxy acrylates, urethane acrylates or polyester acrylates. The polymers may also be blends and copolymers of the preceding chemistries.

Biocompatible coating polymers, such as, poly[-alkoxyalkanoate-co-3-hydroxyalkenoate] (PHAE) polyesters, Geiger et. al. Polymer Bulletin 52, 65-70 (2004), can also serve as binders in the present invention. Alkyd resins, polyesters, polyurethanes, epoxy resins, silicone containing polymers, polyacrylates, polyacrylamides, fluorinated polymers and polymers of vinyl acetate, vinyl alcohol and vinyl amine are non-limiting examples of common coating binders useful in the present invention. Other known coating binders are part of the present disclosure.

Coatings can be crosslinked with, for example, melamine resins, urea resins, isocyanates, isocyanurates, polyisocyanates, epoxy resins, anhydrides, poly acids and amines, with or without accelerators. The compositions described herein can be, for example, a coating applied to a surface which is exposed to conditions favorable for bioaccumulation. The presence of one or more D-amino acids described herein in said coating can prevent the adherence of organisms to the surface.

The D-amino acids described herein can be part of a complete coating or paint formulation, such as a marine gel-coat, shellac, varnish, lacquer or paint, or the anti fouling composition may comprise only a polymer of the instant invention and binder, or a polymer of the instant invention, binder and a carrier substance. Other additives known in the art in such coating formulations or applications are also suitable.

The coating may be solvent borne or aqueous. Aqueous coatings are typically considered more environmentally friendly. In some examples, the coating can be an aqueous dispersion of one or more D-amino acids described herein and a binder or a water based coating or paint. For example, the coating can comprise an aqueous dispersion of one or more D-amino acids and an acrylic, methacrylic or acrylamide polymers or co-polymers or a poly[-alkoxyalkanoate-co-3-hydroxyalkenoate] polyester.

The coating can be applied to a surface which has already been coated, such as a protective coating, a clear coat or a protective wax applied over a previously coated article. Coating systems include marine coatings, wood coatings, other coatings for metals and coatings over plastics and ceramics. Exemplary of marine coatings are gel coats comprising an unsaturated polyester, a styrene and a catalyst. In some examples, the coating is a house paint, or other decorative or protective paint. It can be a paint or other coating that is applied to cement, concrete or other masonry article. The coating may be a water proofer as for a basement or foundation.

In some instances, the coating composition can be applied to a surface by any conventional means including spin coating, dip coating, spray coating, draw down, or by brush, roller or other applicator. A drying or curing period can be performed.

Coating or film thickness can vary depending on the application and can readily be determined by one skilled in the art after limited testing.

In some instances, a composition described herein can be in the form of a protective laminate film. Such a film can comprise thermoset, thermoplastic, elastomeric, or crosslinked polymers. Examples of such polymers include, but are not limited to, polyolefin, polyamide, polyurethane, polyacrylate, polyacrylamide, polycarbonate, polystyrene, polyvinyl acetates, polyvinyl alcohols, polyester, halogenated vinyl polymers such as PVC, natural and synthetic rubbers, alkyd resins, epoxy resins, unsaturated polyesters, unsaturated polyamides, polyimides, fluorinated polymers, silicon containing and carbamate polymers. The polymers can also be blends and copolymers of the preceding chemistries.

When a composition described herein is a preformed film, it can be applied to a surface by, for example, the use of an adhesive, or co-extruded onto the surface. It can also be mechanically affixed via fasteners which may require the use of a sealant or caulk wherein the esters of the instant invention may also be advantageously employed. A plastic film can also be applied with heat which includes calendaring, melt applications and shrink wrapping.

In other instances, a composition described herein can be part of a polish, such a furniture polish, or a dispersant or surfactant formulation such as a glycol or mineral oil dispersion or other formulation as used in for example wood protection. Examples of useful surfactants include, but are not limited to, polyoxyethylene-based surface-active substances, including polyoxyethylene sorbitan tetraoleate (PST), polyoxyethylene sorbitol hexaoleate (PSH), polyoxyethylene 6 tridecyl ether, polyoxyethylene 12 tridecyl ether, polyoxyethylene 18 tridecyl ether, TWEEN® surfactants, TRITON® surfactants, and the polyoxyethlene-polyoxypropylene copolymers such as the PLURONIC® and POLOXAMER® product series (from BASF). Other matrix-forming components include dextrans, linear PEG molecules (MW 500 to 5,000,000), star-shaped PEG molecules, comb-shaped and dendrimeric, hyperbrached PEG molecules, as well as the analogous linear, star, and dendrimer polyamine polymers, and various carbonated, perfluorinated (e.g., DUPONT ZONYL® fluorosurfactants) and siliconated (e.g, dimethylsiloxane-ethylene oxide block copolymers) surfactants.

Given the wide array of applications for the D-amino acids described herein, a D-amino acid-containing composition can include other additives such as antioxidants, UV absorbers, hindered amines, phosphites or phosphonites, benzofuran-2-ones, thiosynergists, polyamide stabilizers, metal stearates, nucleating agents, fillers, reinforcing agents, lubricants, emulsifiers, dyes, pigments, dispersants, other optical brighteners, flame retardants, antistatic agents, blowing agents and the like, such as the materials listed below, or mixtures thereof.

The substrate to be treated can be an inorganic or organic substrate, for example, a metal or metal alloy; a thermoplastic, elastomeric, inherently crosslinked or crosslinked polymer as described above; a natural polymer such as wood or rubber; a ceramic material; glass; leather or other textile. The substrate may be, for example, non-metal inorganic surfaces such as silica, silicon dioxide, titanium oxides, aluminum oxides, iron oxides, carbon, silicon, various silicates and sol-gels, masonry, and composite materials such as fiberglass and plastic lumber (a blend of polymers and wood shavings, wood flour or other wood particles).

The substrate can be a multi-layered article comprised of the same or different components in each layer. The surface coated or laminated may be the exposed surface of an already applied coating or laminate.

The inorganic or organic substrate to be coated or laminated can be in any solid form.

For example, polymer substrates may be plastics in the form of films, injection-molded articles, extruded workpieces, fibres, felts or woven fabrics. For example, molded or extruded polymeric articles used in construction or the manufacture of durable goods such as siding, fascia and mailboxes can all benefit from incorporation of the present D-amino acids. In certain situations, one or more D-amino acids can be incorporated into the polymeric article during the forming, e.g., molding process.

Plastics which would benefit from the present method include, but are not limited to, plastics used in construction or the manufacture of durable goods or machine parts, including outdoor furniture, boats, siding, roofing, glazing, protective films, decals, sealants, composites like plastic lumber and fiber reinforced composites, functional films including films used in displays as well as articles constructed from synthetic fibers such as awnings, fabrics such as used in canvas or sails and rubber articles such as outdoor matting, floor coverings, plastics coatings, plastics containers and packaging materials; kitchen and bathroom utensils (e.g. brushes, shower curtains, sponges, bathmats), latex, filter materials (air and water filters), plastics articles used in the field of medicine, e.g. dressing materials, syringes, catheters etc., so-called “medical devices”, gloves and mattresses. Exemplary of such plastics are polypropylene, polyethylene, PVC, POM, polysulfones, polyethersulfones, polystyrenics, polyamides, polyurethanes, polyesters, polycarbonate, polyacrylics and methacrylics, polybutadienes, thermoplastic polyolefins, ionomers, unsaturated polyesters and blends of polymer resins including ABS, SAN and PC/ABS.

In certain situations, such as incorporation of one or more D-amino acids described herein into recirculating cooling water, a few parts per million of the D-amino acids are effective to prevent biofilm accumulation on the walls of pipes and other mechanical apparatus. However, some loss due to leaching, some loss due to reactions involving the amino acids and some loss to degradation reactions, etc. means that in practice one can prepare formulations having concentrations that will be effective over the period of time envisioned for the application and taking into account the environmental stresses the D-amino acids will be exposed to.

For example, in industrial water applications, about 0.001% to about 10% by weight or for example 0.001% to 10% by weight, of one or more D-amino acids relative to the water being treated can be used, often, an upper limit of less than about 10% can be used, for example about 5%, about 3%, about 2% or even about 1% or less can be effective in many circumstances, for example, load levels of about 0.01% to about 5%, or about 0.01% to about 2% of one or more D-amino acids can be used. In other embodiments, an upper limit of less than 10%, 5%, 3%, 2%, 1%, can be used, such as 0.01% to 5%, or about 0.01% to 2% by weight of one or more D-amino acids can be used. Given the high activity of the instant D-amino acids, very small amounts are effective in many circumstances and concentrations of about 0.000001% to about 0.5%, for example, about 0.000001% to about 0.1% or, about 0.000001% to about 0.01% can be used in industrial water applications. In other embodiments, concentrations of 0.000001% to 0.5%, for example, 0.000001% to 0.1% or 0.000001% to 0.01% can be used in industrial water applications

The D-amino acids, especially in low concentrations, can be safely used even in applications where ingestion is possible, such as reusable water bottles or drinking fountains where a biofilm may develop. The surfaces of such water transport devices can be rinsed with a formulation containing one or more D-amino acids described herein, or low levels of one or more D-amino acids can be introduced into the water that passes through the containers of conduits. For example, about 0.0001% or less or up to about 1%, typically less than about 0.1% by weight of one or more D-amino acids may be introduced into such water. In other examples, 0.0001% or less or up to 1%, typically less than 0.1% by weight of one or more D-amino acids may be introduced into such water. Given the high activity of the instant D-amino acids, very small amounts are effective in many circumstances and concentrations of about 0.000001% to about 0.1%, for example, about 0.000001% to about 0.01%, or about 0.000001% to about 0.001% can be used in such applications. In other examples, concentrations of 0.000001% to 0.1%, 0.000001% to 0.01%, or 0.000001% to 0.001% can be used.

In some instances, liquid formulations are prepared at about 0.0005 μM D-amino acid to about 50 μM D-amino acid, e.g., about 0.001 μM D-amino acid to about 25 μM D-amino acid, about 0.002 μM D-amino acid to about 10 μM D-amino acid, about 0.003 μM D-amino acid to about 5 μM D-amino acid, about 0.004 μM D-amino acid to about 1 μM D-amino acid, about 0.005 μM D-amino acid to about 0.5 μM D-amino acid, about 0.01 μM D-amino acid to about 0.1 μM D-amino acid, or about 0.02 μM D-amino acid to about 0.1 μM D-amino acid. In other embodiments, the liquid formulation is prepared at 0.0005 μM D-amino acid to 50 μM D-amino acid, 0.001 μM D-amino acid to 25 μM D-amino acid, 0.002 μM D-amino acid to 10 μM D-amino acid, 0.003 μM D-amino acid to 5 μM D-amino acid, 0.004 μM D-amino acid to 1 μM D-amino acid, 0.005 μM D-amino acid to 0.5 μM D-amino acid, 0.01 μM D-amino acid to 0.1 μM D-amino acid, or 0.02 μM D-amino acid to 0.1 μM D-amino acid. Preferably, the a D-amino acid composition is at nanomolar concentrations, e.g., at about 5 nM, at about 10 nM, at about 15 nM, at about 20 nM, at about 25 nM, at about 30 nM, at about 50 nM, or more. In other embodiments, the D-amino acid composition is bout 5 nM, at 10 nM, at 15 nM, at 20 nM, at 25 nM, at 30 nM, or at 50 nM.

When used in a coating or film, small amounts of one or more D-amino acids can be present for short term use, for example, one use, seasonal or disposable items, etc. In general, about 0.001% or less up to about 5%, for example up to about 3% or about 2% may be used in such coatings or films. In other embodiments, 0.001% to 5%, or up to 3% or 2% by weight of one or more D-amino acids may be used. Given the high activity of the instant D-amino acids, very small amounts are effective in many circumstances and concentrations of about 0.0001% to about 1%, for example, about 0.0001% to about 0.5%, or about 0.0001% to about 0.01% can be used in coating applications. In other embodiments, concentrations of 0.0001% to 1%, 0.0001% to 0.5%, or 0.0001% to 0.01% by weight of one or more D-amino acids can be used in coating applications.

For more robust uses, for example, coatings for marine, pool, shower or construction materials, higher levels of one or more D-amino acids can be used. For example, from about 0.01% to about 30% based on the coating or film formulation can be employed; in many uses, about 0.01% to about 15%, or to about 10% will be effective, and often about 0.01% to about 5%, or about 0.01% to about 1%, or even about 0.1% or less D-amino acid can be used. In other embodiments, 0.01% to 15%, or 0.01% to 10% will be effective, and often 0.01% to 5%, or 0.01% to 1%, or even 0.1% of one or more D-amino acids can be used.

For incorporation into a molded plastic article, about 0.00001% to about 10% of one or more D-amino acids can be used, for example about 0.0001% to about 3%, for example about 0.001% up to about 1% one or more D-amino acids can be used. In some embodiments, 0.00001% to 10% of one or more D-amino acids can be used, or 0.0001% to 3%, or 0.001% up to 1% of one or more D-amino acids can be used. In situations in which the D-amino acids are impregnated into the surface of an already prepared molded article or fiber, the actual amount of a D-amino-acid present at the surface can depend on the substrate material, the formulation of the impregnating composition, and the time and temperature used during the impregnation step. Given the high activity of the instant D-amino acids, very small amounts are effective in many circumstances, and concentrations of about 0.0001% to about 1%, for example, about 0.0001% to about 0.1%, or about 0.0001% to about 0.01% can be used in plastics. In other embodiments, 0.0001% to 1%, or 0.0001% to 0.1%, or 0.0001% to 0.01% by weight of one or more D-amino acids can be used in plastics

Inhibition or reduction in a biofilm by treatment with a D-amino acid can be measured using techniques well established in the art. These techniques enable one to assess bacterial attachment by measuring the staining of the adherent biomass, to view microbes in vivo using microscopy methods; or to monitor cell death in the biofilm in response to toxic agents. Following treatment, the biofilm can be reduced with respect to the surface area covered by the biofilm, thickness, and consistency (for example, the integrity of the biofilm). Non-limiting examples of biofilm assays include microtiter plate biofilm assays, fluorescence-based biofilm assays, static biofilm assays according to Walker et al., Infect. Immun. 73:3693-3701 (2005), air-liquid interface assays, colony biofilm assays, and Kadouri Drip-Fed Biofilm assays (Merritt et al., (2005) Current Protocols in Microbiology 1.B.1.1-1.B.1.17). Such assays can be used to measure the activity of a D-amino acid on the disruption or the inhibition of formation of a biofilm (Lew et al., (2000) Curr. Med. Chem. 7(6):663-72; Werner et al., (2006) Brief Funct. Genomic Proteomic 5(1):32-6).

In some instances, a D-amino acid can be use in combination with a second agent, e.g., a biocide, an antibiotic, to treat a biofilm or to prevent the formation of a biofilm. An antibiotic can be combined with the D-amino acid either sequentially or simultaneously. For example, any of the compositions described herein can be formulated to include one or more D-amino acids and one or more second agents.

The antibiotic can be any compound known to one of ordinary skill in the art that can inhibit the growth of, or kill, bacteria. Useful, non-limiting examples of antibiotics include lincosamides (clindomycin); chloramphenicols; tetracyclines (such as Tetracycline, Chlortetracycline, Demeclocycline, Methacycline, Doxycycline, Minocycline); aminoglycosides (such as Gentamicin, Tobramycin, Netilmicin, Amikacin, Kanamycin, Streptomycin, Neomycin); beta-lactams (such as penicillins, cephalosporins, Imipenem, Aztreonam); glycopeptide antibiotics (such as vancomycin); polypeptide antibiotics (such as bacitracin); macrolides (erythromycins), amphotericins; sulfonamides (such as Sulfanilamide, Sulfamethoxazole, Sulfacetamide, Sulfadiazine, Sulfisoxazole, Sulfacytine, Sulfadoxine, Mafenide, p-Aminobenzoic Acid, Trimethoprim-Sulfamethoxazole); Methenamin; Nitrofurantoin; Phenazopyridine; trimethoprim; rifampicins; metronidazoles; cefazolins; Lincomycin; Spectinomycin; mupirocins; quinolones (such as Nalidixic Acid, Cinoxacin, Norfloxacin, Ciprofloxacin, Pefloxacin, Ofloxacin, Enoxacin, Fleroxacin, Levofloxacin); novobiocins; polymixins; gramicidins; and antipseudomonals (such as Carbenicillin, Carbenicillin Indanyl, Ticarcillin, Azlocillin, Mezlocillin, Piperacillin) or any salts or variants thereof. Such antibiotics are commercially available, e.g., from Daiichi Sankyo, Inc. (Parsipanny, N.J.), Merck (Whitehouse Station, N.J.), Pfizer (New York, N.Y.), Glaxo Smith Kline (Research Triangle Park, N.C.), Johnson & Johnson (New Brunswick, N.J.), AstraZeneca (Wilmington, Del.), Novartis (East Hanover, N.J.), and Sanofi-Aventis (Bridgewater, N.J.). The antibiotic used will depend on the type of bacterial infection.

Additional known biocides include triclosan, chlorine dioxide, biguanide, chlorhexidine, xylitol, and the like.

Useful examples of antimicrobial agents include, but are not limited to, Pyrithiones, especially the zinc complex (ZPT); Octopirox®; Dimethyldimethylol Hydantoin (Glydant®); Methylchloroisothiazolinone/methylisothiazolinone (Kathon CG®); Sodium Sulfite; Sodium Bisulfite; Imidazolidinyl Urea (Germall 115®, Diazolidinyl Urea (Germain II®); Benzyl Alcohol; 2-Bromo-2-nitropropane-1,3-diol (Bronopol®); Formalin (formaldehyde); Iodoz [symbol] pro [symbol] penyl Butylcarbamate (Polyphase P100®); Chloroacetamide; Methanamine; Methyldibromo [symbol] nitrile Glutaronitrile (1,2-Dibromo-2,4-dicyanobutane or Tektamer®); Glutaraldehyde; 5-bro [symbol] mo-5-nitro-1,3-dioxane (Bronidox®); Phenethyl Alcohol; o-Phenylphenol/sodium o-phenyl [symbol] phenol; Sodium Hydroxymethylglycinate (Suttocide A®); Polymethoxy Bicyclic Oxazolidine (Nuosept C®); Dimethoxane; Thimersal; Dichlorobenzyl Alcohol; Captan; Chlorphenenesin; Dichlorophene; Chlorbutanol; Glyceryl Laurate; Halogenated Diphenyl Ethers; 2,4,4′-trichloro-2′-hydroxy-diphenyl ether (Triclosan®. or TCS); 2,2′-dihydroxy-5,5′-dibromo-diphenyl ether; Phenolic Compounds; Phenol; 2-Methyl Phenol; 3-Methyl Phenol; 4-Methyl Phenol; 4-Ethyl Phenol; 2,4-Dimethyl Phenol; 2,5-Dimethyl Phenol; 3,4-Dimethyl Phenol; 2,6-Dimethyl Phe [symbol] nol; 4-n-Propyl Phenol; 4-n-Butyl Phenol; 4-n-Amyl Phenol; 4-tert-Amyl Phenol; 4-n-Hexyl Phenol; 4-n-Heptyl Phenol; Mono- and Poly-Alkyl and Aromatic Halophenols; p-Chloro [symbol] phe [symbol] nol; Methyl p-Chlorophenol; Ethyl p-Chlorophenol; n-Propyl p-Chlorophenol; n-Butyl p-Chloro [symbol] phenol; n-Amyl p-Chlorophenol; sec-Amyl p-Chlorophenol; Cyclohexyl p-Chloro [symbol] phe [symbol] nol; n-Heptyl p-Chlorophenol; n-Octyl p-Chlorophenol; o-Chlorophenol; Methyl o-Chloro [symbol] phenol; Ethyl o-Chlorophenol; n-Propyl o-Chlorophenol; n-Butyl o-Chlorophenol; n-Amyl o-Chloro [symbol] phenol; tert-Amyl o-Chlorophenol; n-Hexyl o-Chlorophenol; n-Heptyl o-Chlorophenol; o-Ben [symbol] zyl p-Chlorophenol; o-Benxyl-m-methyl p-Chlorophenol; o-Benzyl-m; m-dimethyl p-Chloro [symbol] phenol; o-Phenylethyl p-Chlorophenol; o-Phenylethyl-m-methyl p-Chlorophenol; 3-Methyl p-Chlorophenol; 3,5-Dimethyl p-Chlorophenol; 6-Ethyl-3-methyl p-Chlorophenol; 6-n-Propyl-3-methyl p-Chlorophenol; 6-iso-Propyl-3-methyl p-Chlorophenol; 2-Ethyl-3,5-dimethyl p-Chloro [symbol] phenol; 6-sec-Butyl-3-methyl p-Chlorophenol; 2-iso-Propyl-3,5-dimethyl p-Chlorophenol; 6-Diethylmethyl-3-methyl p-Chlorophenol; 6-iso-Propyl-2-ethyl-3-methyl p-Chlorophenol; 2-sec-Amyl-3,5-dimethyl p-Chlorophenol; 2-Diethylmethyl-3,5-dimethyl p-Chlorophenol; 6-sec-Octyl-3-methyl p-Chlorophenol; p-Chloro-m-cresol: p-Bromophenol; Methyl p-Bromophenol; Ethyl p-Bromophenol; n-Propyl p-Bromophenol; n-Butyl p-Bromophenol; n-Amyl p-Bromo [symbol] phenol; sec-Amyl p-Bromophenol; n-Hexyl p-Bromophenol; Cyclohexyl p-Bromophenol; o-Bromophenol; tert-Amyl o-Bromophenol; n-Hexyl o-Bromophenol; n-Propyl-m,m-Dimethyl o-Bromophenol; 2-Phenyl Phenol; 4-Chloro-2-methyl phenol; 4-Chloro-3-methyl phenol; 4-Chloro-3,5-dimethyl phenol; 2,4-Dichloro-3,5-dimethylphenol; 3,4,5,6-Terabromo-2-methyl [symbol] phenol; 5-Methyl-2-pentylphenol; 4-Isopropyl-3-methylphenol; Para-chloro-meta-xylenol (PCMX); Chlorothymol; Phenoxyethanol; Phenoxyisopropanol; 5-Chloro-2-hydroxydi [symbol] phenyl [symbol] methane; Resorcinol and its Derivatives; Resorcinol; Methyl Resorcinol; Ethyl Resorcinol; n-Propyl Resorcinol; n-Butyl Resorcinol; n-Amyl Resorcinol; n-Hexyl Resorcinol; n-Heptyl Re [symbol] sorcinol; n-Octyl Resorcinol; n-Nonyl Resorcinol; Phenyl Resorcinol; Benzyl Resorcinol; Phe [symbol] nylethyl Resorcinol; Phenylpropyl Resorcinol; p-Chlorobenzyl Resorcinol; 5-Chloro 2,4-Dihy [symbol] droxy [symbol] diphenyl Methane; 4′-Chloro 2,4-Dihydroxydiphenyl Methane; 5-Bromo 2,4-Dihydroxy [symbol] diphenyl Methane; 4′-Bromo 2,4-Dihydroxydiphenyl Methane; Bisphenolic Compounds; 2,2′-Methylene bis-(4-chlorophenol); 2,2′-Methylene bis-(3,4,6-trichlorophenol); 2,2′-Methylene bis [symbol] (4-chloro-6-bromophenol); bis(2-hydroxy-3,5-dichlorophenyl)sulfide; bis(2-hydroxy-5-chlo [symbol] ro [symbol] benzyl)sulfide; Benzoic Esters (Parabens); Methylparaben; Propylparaben; Butylpara [symbol] ben; Ethylparaben; Isopropylparaben; Isobutylparaben; Benzylparaben; Sodium Methylpara [symbol] ben; Sodium Propylparaben; Halogenated Carbanilides; 3,4,4′-Trichlorocarbanilides (Triclo [symbol] car [symbol] ban® or TCC); 3-Trifluoromethyl-4,4′-dichlorocarbanilide; 3,3′,4-Trichlorocarbanilide; Chlorohexidine and its digluconate; diacetate and dihydrochloride; Undecenoic acid; thiabendazole, Hexetidine; poly(hexamethylenebiguanide) hydrochloride (Cosmocil®); silver compounds such as organic silver salts it anorganic silver salts, silver chloride including formulations thereof such as JM Acticare® and micronized silver particles.

The invention is further described in the following examples, which do not limit the scope of the invention described in the claims. Room temperature denotes a temperature from the range of 20-25° C.

### EXAMPLES

### Materials and Methods

Strains and media. Bacillus subtilis NCIB3610 and its derivatives were grown in Luria-Bertani (LB) medium at 37° C. or MSgg medium (Branda et al., Proc. Natl. Acad. Sci. USA 98:11621 (2001)) at 23° C. Solid media contained 1.5% Bacto agar. When appropriate, antibiotics were added at the following concentrations for growth of B. subtilis:10 μg per ml of tetracycline, and 5 μg per ml of erythromycin, 500 μg per ml of spectinomycin.

Strains used in this work:

All B. subtilis strains are derivatives of NCIB 3610, a wild strain that forms robust biofilms (Branda et al., Proc. Natl. Acad. Sci. USA 98:11621 (2001));

Strain FC5(P_{epsA}-lacZ cat) (Chu et al., Mol. Microbiol. 59:1216 (2006));

Strain FC122 (P_{yqxM}-lacZ spec) (Chu et al., Mol. Microbiol. 59:1216 (2006));

Strain IKG55 (ΔracX::spec ΔylmE::tetR);

Strain DR-30 (tasA-mCherry cat);

Strain IKG40 (yqxM2);

Strain IKG44 (yqxM6);

Strain IKG50 (yqxM2 tasA-mCherry);

Strain IKG51 (yqxM6 tasA-mCherry);

Staphylococcus aureus SC01 from the Kolter lab collection.

Strain construction. Strains were constructed using standard methods (J. Sambrook, D. W. Russell, Molecular Cloning. A Laboratory Manual. (Cold Spring Harbor Laboratory Press, Cold Spring Harbor, N.Y., USA, 2001). Long-flanking PCR mutagenesis was used to create ΔracX::spec and ΔylmE::tetR (Wach, Yeast 12:259 (1996)). DNA was introduced into strain PY79 derivatives by DNA-mediated transformation of competent cells (Gryczan et al., J. Bacteriol. 134:318 (1978)). SPP1 phage-mediated transduction was used to introduce antibiotic resistance-linked mutations from PY79 derivatives into NCIB3610 (Yasbin et al., J. Virol. 14:1343 (1974)).

Reagents. Amino acids were obtained from Sigma-Aldrich (St. Louis, Mo.). ¹⁴C-D-tyrosine and ¹⁴C-L-proline were obtained from American Radiolabeled Chemicals, Inc (St. Louis, Mo.).

Colony and pellicle formation. For colony formation on solid medium, cells were first grown to exponential growth phase in LB broth and 3 μl of culture were spotted onto solid MSgg medium containing 1.5% Bacto agar. The plates were incubated at 23° C. For pellicle formation in liquid medium, cells were grown to exponential phase and 6 μl of culture were mixed with 6 ml of medium in a 12-well plate (VWR). Plates were incubated at 23° C. Images of colonies and pellicles were taken using a SPOT camera (Diagnostic Instruments, USA).

Preparing conditioned medium. Cells were grown in LB medium to exponential phase. 0.1 ml of culture was added to 100 ml of MSgg medium and grown without shaking in a 500 ml beaker at 23° C. Next, pellicles and conditioned medium was collected by centrifugation at 8,000 rpm for 15 min. The conditioned medium (supernatant fluid) was removed and filtered through a 0.22 μm filter. The filtrates were stored at 4° C. For further purification the biofilm-inhibiting activity was fractionated on a C-18 Sep Pak cartridge using stepwise elution of 0% to 100% methanol with steps of 5%.

Identification and quantification of D-amino acids in the conditioned medium. (A) Amino acid quantification. Standard solutions of Tyr, Leu, Met, and Trp were prepared at various concentrations (0.001-0.2 mM). These solutions were analyzed by LC/MS with a step gradient solvent system from 0% to 60% then to 100% CH₃CN with 0.1% formic acid (0-12-20 min) (Thermo Scientific Hypercarb 4.6 mm×100 mm, 5 μm) to obtain calibration curves of each amino acid concentration by ion count integration. Conditioned media samples were analyzed by LC/MS in the same manner to measure the total concentrations of all four chiral amino acids. (B) Identification of D-amino acids. The sample was dried in SpeedVac and dissolved in 100 μL 1 N NaHCO₃. 10 mg/mL of L-FDAA (N-(2,4-dinitro-5-fluoro-phenyl)-L-alanineamide) solution was prepared in acetone and 50 μL of the acetone solution was added to the sample in 1N NaHCO₃. The reaction mixture was incubated at 80° C. for 5 min and 50 μL of 2N HCl was added to quench the reaction. The derivatives were analyzed by LC/MS using a gradient solvent system from 10% to 100% CH₃CN with 0.1% formic acid over 30 min (Agilent 1200 Series HPLC/6130 Series MS, Phenomenex Luna C18, 4.6 mm×100 mm, 5 μm). The retention times of L-FDAA-amino acids were compared with L-FDAA-authentic standard amino acids.

Crystal violet staining Crystal violet staining was done as described previously (O'Toole et al., Mol. Microbiol. 30:295 (1998)) except that the cells were grown in 6-well plates. Wells were stained with 500 μl of 1.0% Crystal-violet dye, rinsed twice with 2 ml double-distilled water and thoroughly dried.

Fluorescence microscopy. For fluorescence microscopy analysis, 1 ml of culture was harvested. The cells were washed with PBS buffer and suspended in 50 μl of PBS buffer. Cover slides were pretreated with poly L-lysine (Sigma). Samples were examined using an Olympus workstation BX61 microscope. Images were taken using the automated software program SimplePCI and analyzed with program MetaMorph (Universal Imaging Corporation).

Transmission electron microscopy and immunolabeling. Samples were diluted with distilled water and adsorbed onto a carbon or formvar/carbon coated grid. The grid surface was made hydrophilic prior to use with glow discharge in a vacuum evaporator. Once the specimen was adsorbed onto the film surface, the excess sample was blotted off on a filter paper (Whatman #1) and the grid was floated on 5 μl of stain solution (1-2% aqueous uranyl acetate) for a few minutes and then blotted off. The samples were dried and examined in a Tecnai™ G² Spirit BioTWIN microscope at an accelerating voltage of 80 KV. Images were taken with an AMT 2k CCD camera.

For immunolocalization of TasA, diluted samples on nickel grids were floated on blocking buffer consisting of 1% nonfat dry milk in PBS with 0.1% Tween 20 for 30 min, incubated for 2 h with anti-TasA primary antibody diluted 1:150 in blocking buffer, rinsed in PBST, then exposed to goat-anti-rabbit 20 nm gold secondary antibody (Ted Pella, Inc., Redding, Calif.) for 1 h and rinsed. All grids were stained with uranyl acetate and lead citrate, then viewed as described above.

Assays of β-galactosidase activity. Cells were cultured in MSgg medium at 37° C. in a water bath with shaking 1 ml of culture was collected at each time point. β-galactosidase activity was determined as described previously (Chai et al., Mol. Microbiol. 67:254 (2008)).

Incorporation of amino acids into the cell wall. Cells in 50 ml of culture at the mid exponential phase of growth were harvested by centrifugation and washed with 0.05 M of phosphate buffer (pH 7) and re-suspended in 5 ml of the same buffer. Cells were either treated with 10 μCi/ml of ¹⁴C-D-tyrosine or ¹⁴C-L-proline and further incubated at 37° C. for 2 hours. The radioactivity of whole cells and cell wall fraction was monitored, and, at intervals samples were removed. For measurement of incorporation into whole cells, 0.1 ml samples were collected. For measurements of incorporation into cell wall, 0.5 ml samples were collected. The cells were harvested by centrifugation and re-suspended in SM buffer [0.5 M sucrose, 20 mM MgCl₂, and 10 mM potassium phosphate at pH (6.8)] containing 0.1 mg/ml lysozyme. The cells were then incubated at 37° C. for 10 min. Next, the resulting protoplasts were removed by centrifugation at 5000 rpm for 10 min, leaving the cell wall material in the supernatant fluid. That the cell wall fraction was free of protein was confirmed by immunoblot analysis using an anti-sigma A antibodies. Finally, 10 ml of 5% trichloroacetic acid was added to the whole cell samples and the cell wall material and maintained on ice for at least 30 min. The TCA-insoluble material was collected on Millipore filters (0.22 μm pore size, Millipore) and washed with 5% TCA. The filters were air-dried and placed in scintillation vials and the TCA-insoluble counts per minute were determined using a scintillation counter.

### Example 1

### Screening of D-Amino Acids in Biofilm Formation by B. Subtilis

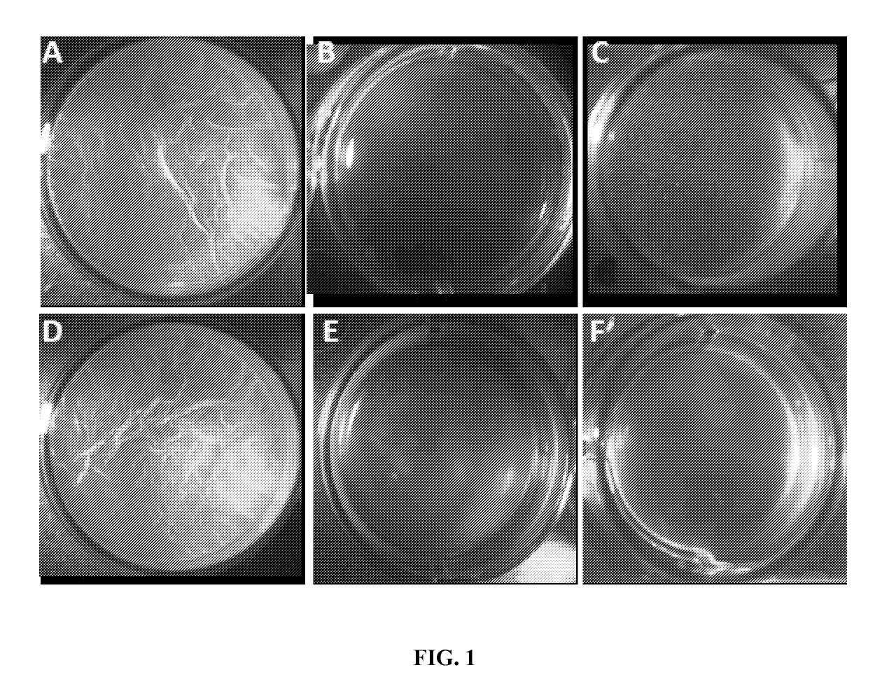

B. subtilis forms thick pellicles at the air/liquid interface of standing cultures after three days of incubation in biofilm-inducing medium (FIG. 1A). Upon incubation for an additional three to five days, however, the pellicle loses its structural integrity (FIG. 1-B). To investigate whether mature biofilms produce a factor that triggers biofilm disassembly, the effect of concentrated and partially purified extracts of conditioned medium on pellicle formation when added to fresh medium was assayed. To this end, conditioned medium from an eight-day-old culture was applied to a C18 Sep Pak column. Concentrated eluate from the column was then added to a freshly inoculated culture. An amount of concentrated eluate corresponding to 25% of the material from an equivalent volume of conditioned medium was sufficient to prevent pellicle formation (FIG. 1C). As a control, it was observed that addition of concentrated eluate prepared using conditioned medium from a three-day-old culture had little or no effect on pellicle formation (FIG. 1D). Further purification of the factor was achieved by eluting the cartridge in step-wise fashion with increasing concentrations of methanol. Elution with 40% methanol resulted in a fraction that was highly active in inhibiting pellicle formation (FIG. 1E). Yet, this material had little or no effect on cell growth. The biofilm-inhibiting activity was resistant to heating at 100° C. for 2 hours and proteinase K treatment (FIG. 1F).

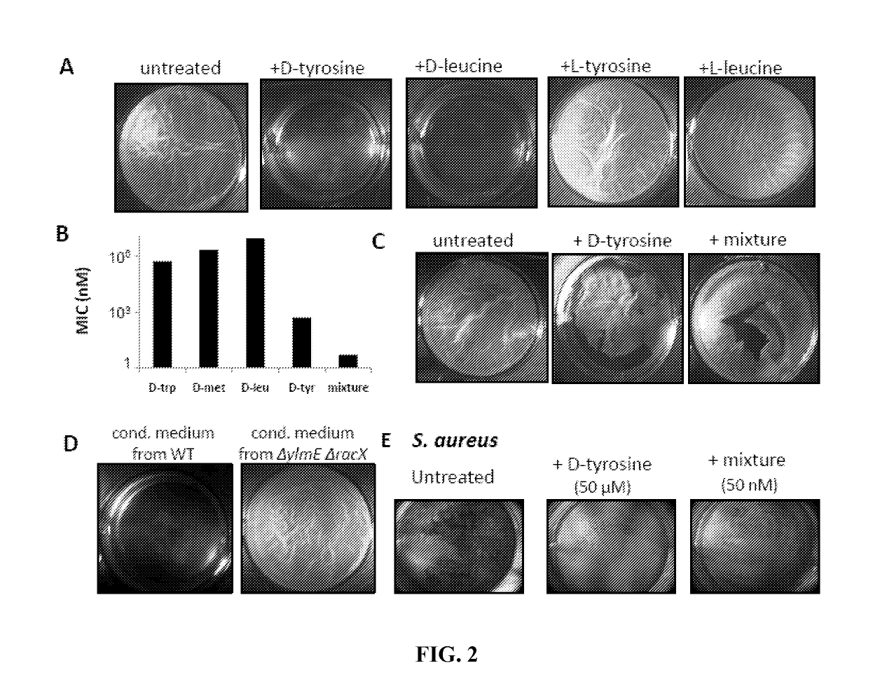

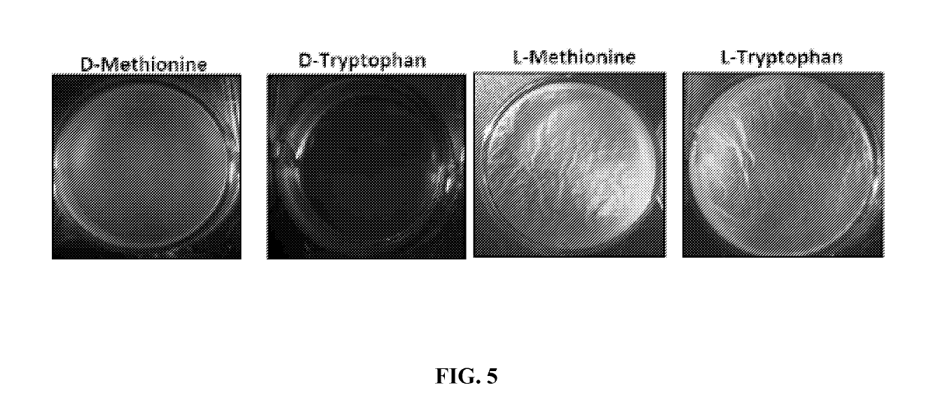

D-tyrosine, D-leucine, D-tryptophan, and D-methionine were screened for inhibiting biofilm formation by B. subtilis both in liquid and on solid medium (FIGS. 2A, 5, 6). FIG. 2A shows the effects on pellicle formation of adding D-tyrosine (3 μM), D-leucine (8.5 mM), L-tyrosine (7 mM), or L-leucine (8.5 mM) to freshly inoculated cultures in biofilm-inducing medium after incubation for 3 days. Both D-tyrosine and D-leucine showed significant inhibition of biofilm growth, as compared to the corresponding L-amino acids. Similarly, FIG. 5 shows wells containing MSgg medium supplemented with D-tryptophan (0.5 mM), D-methionine (2 mM), L-tryptophan (5 mM) or L-methionine (5 mM) that were inoculated with strain NCIB3610 and incubated for 3 days. Only the D-amino acids were active in inhibiting biofilm formation.

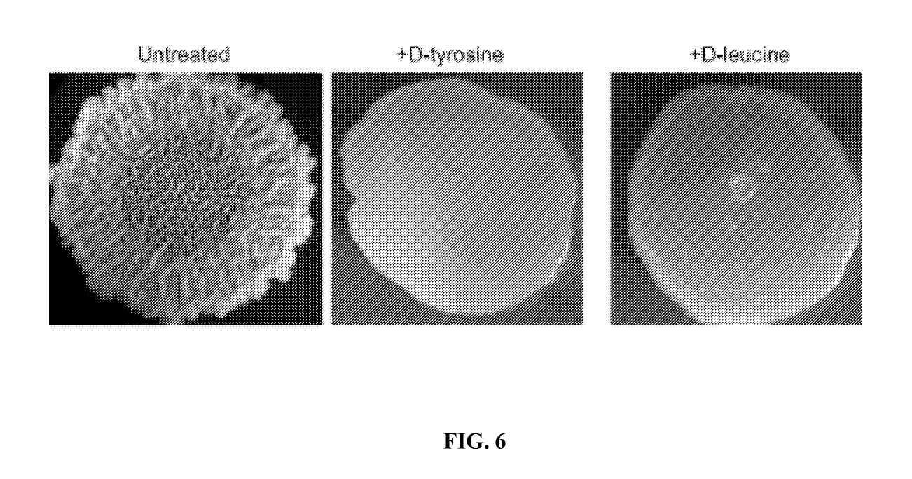

FIG. 6 shows plates containing solid MSgg medium supplemented with D-tyrosine (3 μM) or D-leucine (8.5 mM) that were inoculated with strain NCIB3610 and incubated for 4 days. Both D-tyrosine and D-leucine inhibited biofilm formation.

D-methionine, D-tryptophan, D-tyrosine and D-leucine showed significant inhibition of biofilm growth, as compared to the corresponding L-amino acids. In contrast, the corresponding L-isomers and D-isomers of other amino acids, such as D-alanine and D-phenylalanine, were not effective in the biofilm-inhibition assay for B. subtilis.

Next, the minimum concentration (MIC for Minimal Inhibitory Concentration) needed to prevent biofilm formation was determined. As shown in FIG. 2B, individual D-amino acids varied in their activity, with D-tyrosine being the most effective. D-methionine, D-tryptophan, and D-leucine had MICs of around 1 mM, while D-tyrosine has an MIC of about 100 nM. Strikingly, a mixture of all four D-amino acids (in equimolar amounts) was particularly potent, with a MBIC of <10 nM. Thus, D-amino acids act synergistically. The D-amino acids not only prevented biofilm formation but also disrupted existing biofilms. FIG. 2C shows 3 day-old cultures to which had been added no amino acids (untreated), D-tyrosine (3 μM) or a mixture of D-tyrosine, D-tryptophan, D-methionine and D-leucine (2.5 nM each), followed by further incubation for 8 hours. Addition of D-tyrosine or a mixture of the four D-amino acids caused the conspicuous breakdown of pellicles within a period of 8 hours.

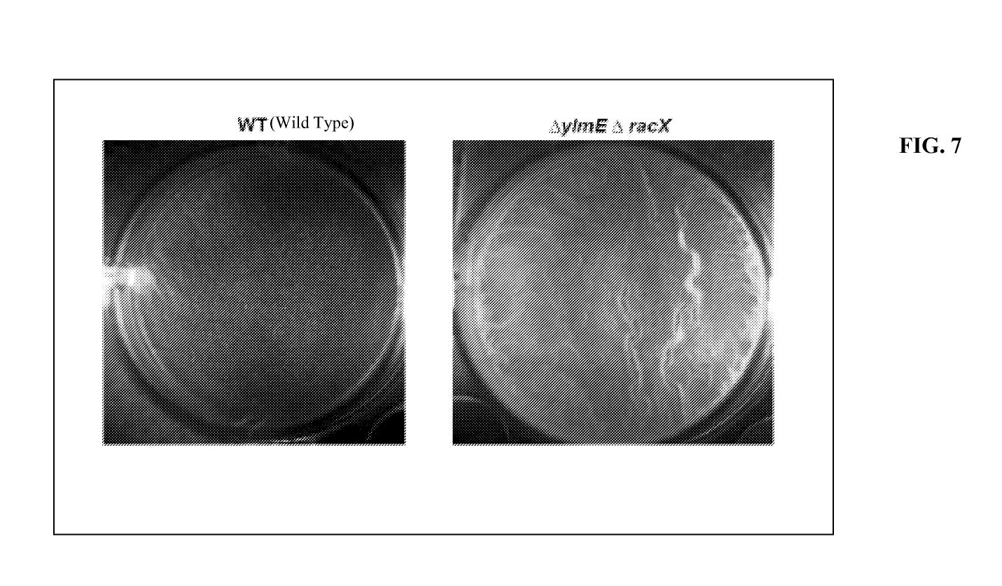

D-amino acids are generated by amino acid racemases, enzymes that convert the α-carbon stereocenter of these amino acids from L- to D-forms (Yoshimura et al., J. Biosci. Bioeng. 96:103 (2003)). Genetic evidence consistent with the idea that the biofilm-inhibiting factor is D-amino acids was obtained using mutants of ylmE and racX, genes whose predicted products exhibit sequence similarity to known racemases. Strains mutant for ylmE or racX alone showed a modest delay in pellicle disassembly (data not shown). FIG. 7 shows NCIB3610 (WT) and a mutant strain doubly deleted for ylmE and racX (IKG155) that were grown in 12 well plates and incubated for 5 days. Pellicles formed by cells doubly mutant for the putative racemases were significantly delayed in disassembly, suggesting that the strains in which racemase activity is especially reduced also exhibit reduced antibiofilm inhibition. Also, conditioned medium from the double mutant was ineffective in inhibiting biofilm formation, in contrast to conditioned medium from the wild type. FIG. 2D shows the effect of concentrated Sep Pak C-18 column eluate from conditioned medium from an 8-day-old culture from the wild type or from a strain (IKG55) doubly mutant for ylmE and racX, in which the double mutant shows significant biofilm buildup.

Next, it was determined whether D-amino acids were produced during biofilm maturation and in sufficient abundance to account for disassembly of mature biofilms. Accordingly, LC/MS was carried out, followed by the identification of the D-amino acids using derivatization with Nα-(2,4-dinitro-5-fluorophenyl)-L-alaninamide (L-FDAA) on conditioned medium collected at early and late times after pellicle formation. The results showed that D-tyrosine (6 μM), D-leucine (23 μM), and D-methionine (5 μM) were present at concentrations at or above those needed to inhibit biofilm formation by day 6 but at concentrations of <10 nM at day 3, e.g., at a level that is not sufficient to inhibit biofilm formation.

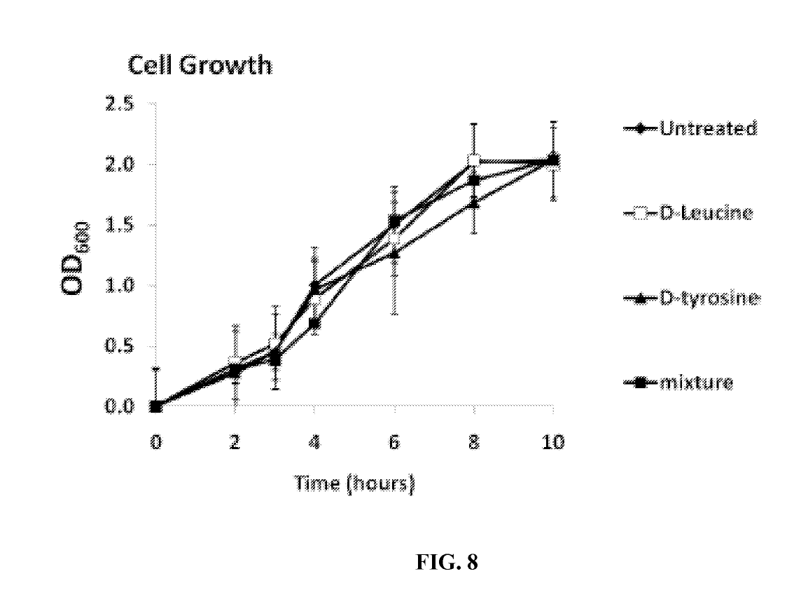

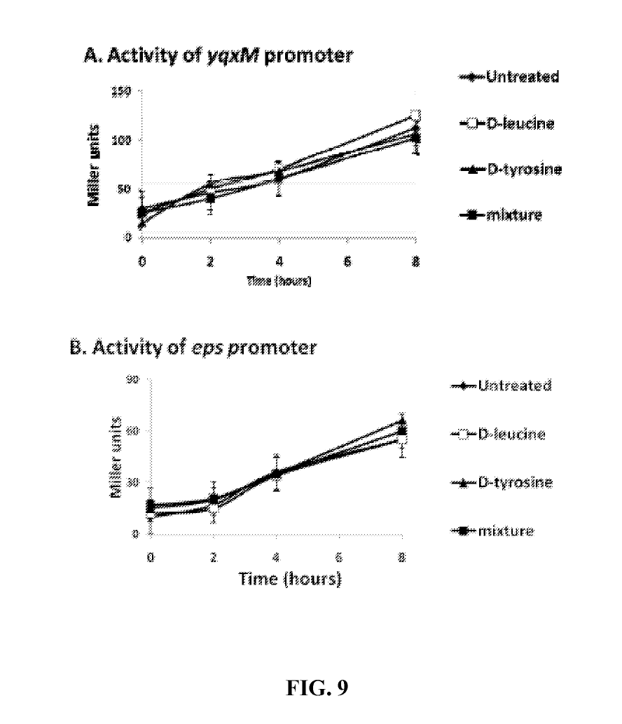

Similarly to the conditioned medium, D-amino acids did not inhibit cell growth, nor did they inhibit the expression of the matrix operons eps and yqxM (FIGS. 8-9). FIG. 8 shows the effect of D-amino acids on cell growth. Cells were grown in MSgg medium containing D-tyrosine (3 μM), D-leucine (8.5 mM) or the four D-amino acids mixture (2.5 nM each) with shaking Cell growth in the D-amino acid treated cultures was substantially the same as the untreated sample. FIG. 9A shows the expression of P_{yqxM}-lacZ by strain FC122 (carrying P_{yqxM}-lacZ) and FIG. 9B shows the expression of P_{epsA}-lacZ by strain FC5 (carrying P_{epsA}-lacZ) that were grown in MSgg medium containing D-tyrosine (3 μM), D-leucine (8.5 mM) or the four D-amino acids mixture (2.5 nM each) with shaking Again, yqxM and eps expression for the D-amino acid treated samples were substantially the same as the untreated sample.

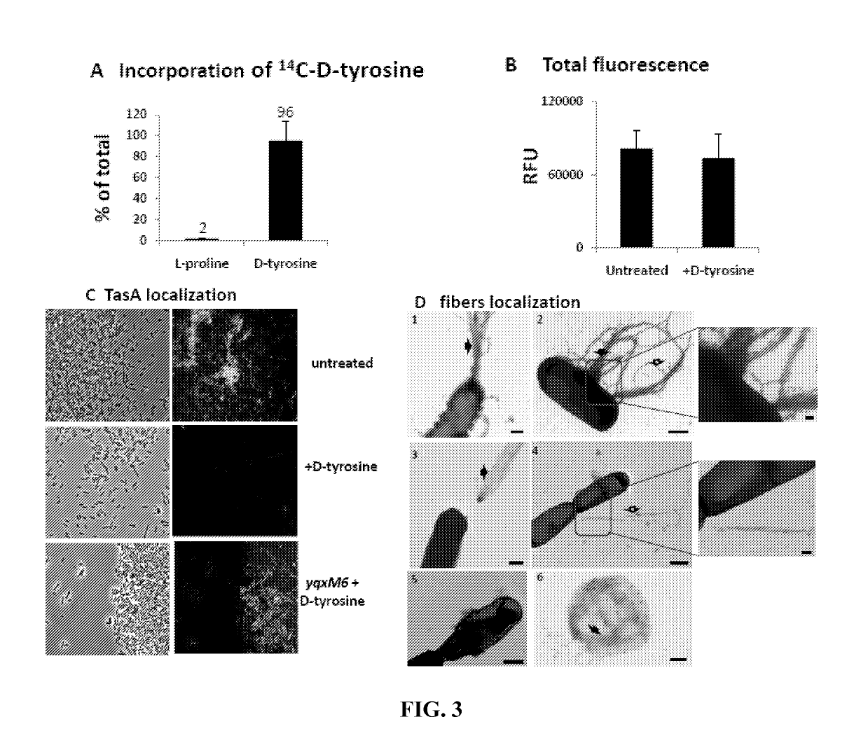

It was previously reported that D-amino acids are incorporated into the peptide cross bridge of the peptidoglycan component of the cell wall. To confirm, cells were grown in biofilm-inducing medium and incubated with either ¹⁴C-D-tyrosine or ¹⁴C-L-proline (10 μCi/ml) for 2 h at 37° C. FIG. 3A shows incorporation of radioactive D-tyrosine into the cell wall. Using ¹⁴C -D-tyrosine, D-tyrosine (but not ¹⁴C -L-proline) was shown to be incorporated into the cell wall. Results are presented as a percent of total incorporation into cells (360,000 cpm/ml for L-proline and 46,000 cpm/ml for D-tyrosine).

To investigate whether D-amino acids incorporated into the cell wall can disengage TasA fibers from being anchored to the cell, the localization of a functional fusion of TasA with the fluorescent reporter mCherry was examined. FIG. 3B shows total fluorescence from cells containing a functional tasA-mCherry translational fusion. The cells were grown to stationary phase with shaking in biofilm-inducing medium in the presence or absence of D-tyrosine (6 μM). As shown in FIG. 3B, treatment with D-tyrosine had little or no effect on the total accumulation of TasA-mCherry. In contrast, when the cells were washed by centrifugation, resuspended and then examined by fluorescence microscopy, untreated cells (which were often in clumps) were seen to be intensely decorated with TasA-mCherry. In contrast, D-tyrosine-treated cells (which were largely unclumped) showed only low levels of fluorescence. Similar results were obtained with D-leucine and with the four D-amino acid equimolar mixture. The localization of unmodified TasA protein was also analyzed by transmission electron microscopy using gold-labeled anti-TasA antibodies. FIG. 3D shows cell association of TasA fibers by electron microscopy. 24-hour-old cultures were incubated without (images 1 and 2) or with (images 3-6) D-tyrosine (0.1 mM) for an additional 12 hours. TasA fibers were stained by immunogold labeling using anti-TasA antibodies, and visualized by transmission electron microscopy as described in the Examples. The cells were mutant for the eps operon (Δeps) as the absence of exopolysaccharide significantly improves the imaging of TasA fibers. Filled arrows indicate fiber bundles; open arrows indicate individual fibers. The scale bar is 500 nm. The scale bar in the enlargements of images 2, 4 and 6 is 100 nm. Images 1 and 2 show fiber bundles attached to cells, images 3, 4 and 6 show individual fibers and bundles detached from cells, and images 3-5 show cells with little or no fiber material. TasA fibers were seen as being anchored to the cells of untreated pellicles (FIG. 3D, images 1 and 2). In contrast, cells treated for 12 hours with D-tyrosine consisted of a mixture of cells that were largely undecorated with TasA fibers and free TasA fibers or aggregates of fibers that were not anchored to cells (FIG. 3D, images 3-6). Without wishing to be bound by theory, one of the mechanisms by which D-tyrosine treats biofilms may be to induce the shedding of fibers by the cells.

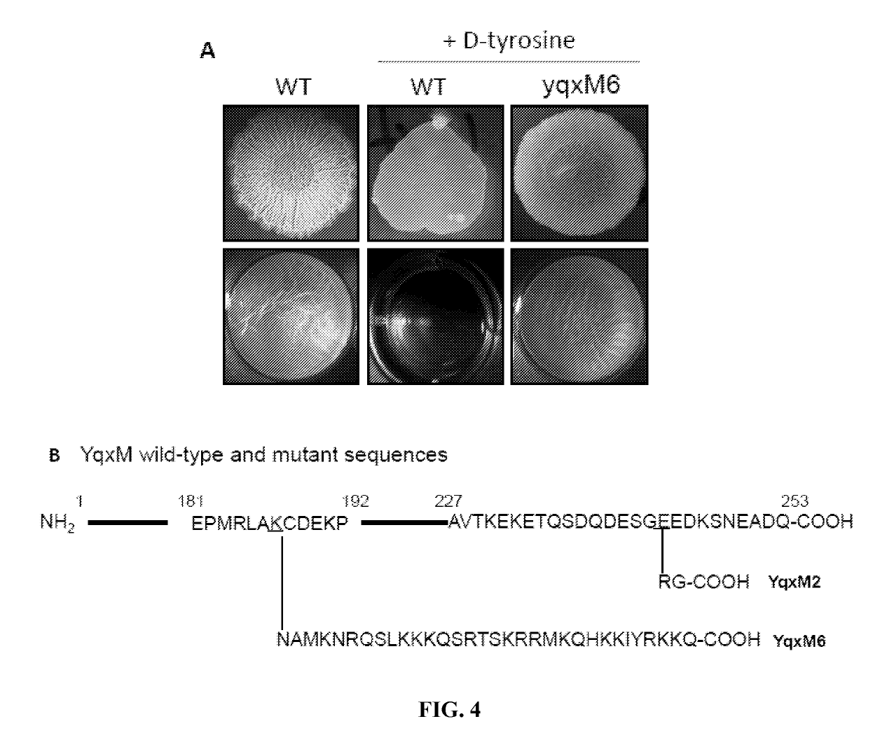

Genetic evidence that D-amino acids act by disrupting the anchoring of TasA fibers to the cells was obtained from the isolation of D-tyrosine resistant mutants. FIG. 4A shows cells grown for 3 days on solid (top images) or liquid (bottom images) biofilm-inducing medium that did or did not contain D-tyrosine. Wrinkled papillae appeared spontaneously on the flat colonies formed during growth on solid medium containing D-tyrosine (FIG. 4A) or D-leucine (data not shown). Importantly, no such papillae appeared on plates containing all four active D-amino acids. When purified, these spontaneous mutants gave rise to wrinkled colonies and pellicles in the presence of D-tyrosine or D-leucine. Several such mutants were isolated and most of them contained a mutation in or near the yqxM operon. Two mutations were examined in detail and found to be frame-shift mutations near the 3′ end of the 759 base-pair-long yqxM gene. yqxM2 was an insertion of G:C at base pair 728 in the yqxM open-reading frame and yqxM6 was a deletion of A:T at base pair 568 (FIG. 4B). FIG. 4B shows an abbreviated amino acid sequence for YqxM. Underlined are residues specified by codons in which the yqxM2 and yqxM6 frame-shift mutations resulted in the indicated sequence changes.

FIG. 3C shows cell association of TasA-mCherry by fluorescence microscopy. Wild-type cells and yqxM6 (IKG51) mutant cells containing the tasA-mCherry fusion were grown to stationary phase (OD=1.5) with shaking in biofilm-inducing medium in the presence or absence (untreated) of D-tyrosine (6 μM) as indicated, washed in PBS, and visualized by fluorescence microscopy. Fluorescence microscopy showed that the presence of yqxM2 and yqxM6 restored clumping and cell decoration by TasA-mCherry to cells treated with D-tyrosine (FIG. 3C). Previous work has shown that YqxM is required for the association of TasA with cells (Branda et al., Mol. Microbiol. 59:1229 (2006)). Without wishing to be bound by theory, this discovery that the biofilm-inhibiting effect of D-amino acids can be overcome by mutants of YqxM reinforces the view that the effect of D-amino acid incorporation into the cell wall is to impair the anchoring of the TasA fibers to the cell. A domain near the C-terminus of YqxM may trigger the release of TasA in response to the presence of D-tyrosine or D-leucine in the cell wall.

### Example 2

### Screening of D-Amino Acids in Biofilm Formation by S. aureus and P. aeruginosa

The effect of D-amino acids on biofilm formation by other bacteria was examined. The pathogenic bacterium Staphylococcus aureus forms biofilms on plastic surfaces (Otto, Curr. Top. Microbiol. Immunol. 322:207 (2008)), which can be detected by washing away unbound cells and staining the bound cells with crystal violet. FIG. 2E shows S. aureus (strain SCO1) that had been grown in 12-well polystyrene plates for 24 hours at 37° C. in TSB medium containing glucose (0.5%) and NaCl (3%). Additionally added to the wells were no amino acids (untreated), D-tyrosine (50 μM) or the D-amino acid mixture (15 nM each). Cells bound to the polystyrene were visualized by washing away unbound cells and then staining with crystal violet. FIG. 2E shows that 50 μM concentrations of D-tyrosine and 50 nM concentrations of mixed D-amino acids (D-tyrosine, D-leucine, D-tryptophan, and D-methionine; 50 nM each) were highly effective in preventing biofilm formation by the pathogenic bacterium.

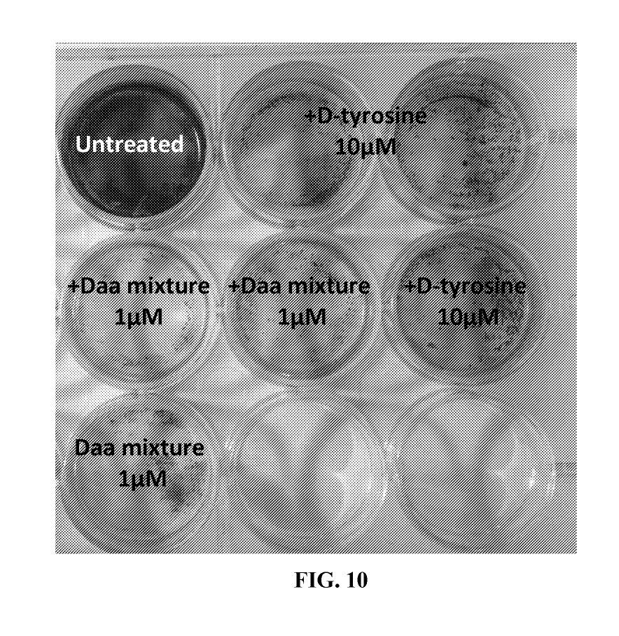

In addition, FIG. 10 demonstrates that 10 μM of D-tyrosine was effective in preventing biofilm formation by Pseudomonas aeruginosa, whereas 1 μM of an equimolar mix of D-tyrosine, D-leucine, D-tryptophan, and D-methionine was effective. FIG. 10 shows the inhibition of Pseudomonas aeruginosa biofilm formation by D-amino acids. P. aeruginosa strain P014 was grown in 12-well polystyrene plates for 48 hours at 30° C. in M63 medium containing glycerol (0.2%) and Casamino acids (20 μg/ml). Additionally added to the wells were no amino acids (untreated), D-tyrosine or the D-amino acid equimolar mixture. Cells bound to the polystyrene were visualized by washing away unbound cells and then staining with crystal violet. Wells were stained with 500 μl of 1.0% Crystal-violet dye, rinsed twice with 2 ml double-distilled water and thoroughly dried.

### Example 3

### D-Amino Acids Mixtures Active in Inhibiting Staphylococcus aureus and Pseudomonas aeruginosa Biofilms

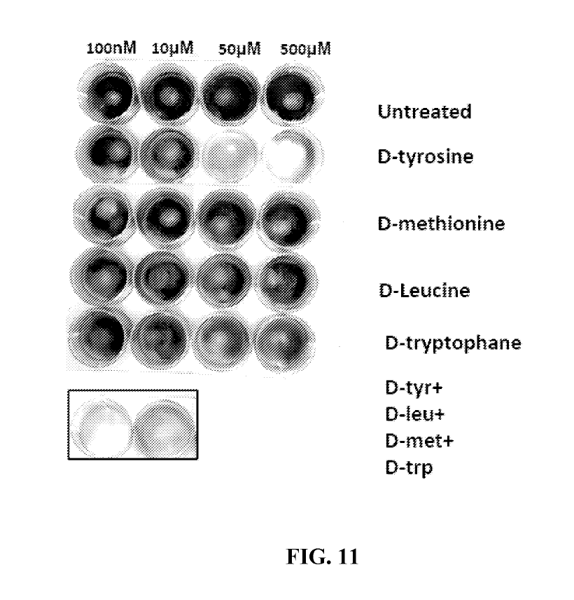

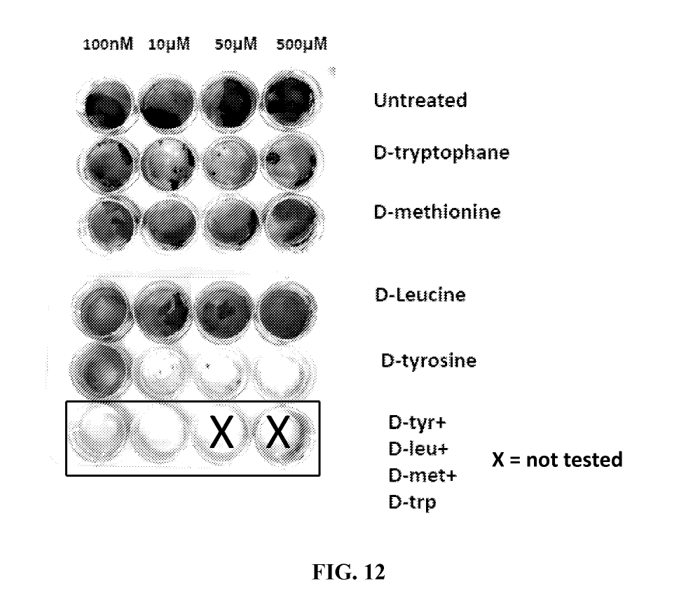

Two different mixtures are very active in preventing the formation of Staphylococcus aureus biofilms. One is an equimolar mixture of D-tyrosine, D-methionine, D-leucine and D-tryptophan. The D-aa mixture of D-trp, D-met, D-tyr and D-leu was active in significantly lower concentration than the individual amino acids in all tested bacterial strains B. subtilis, Staphylococcus aureus (FIG. 11), and Pseudomonas aeruginosa (FIG. 12). For experiments reported in Table 1, the organism/strain was S.a. Harvard SCO1, the culture medium was TSB and the cell inoculation was at 2×10⁹ cfu. For experiments reported in Table 2, the organism/strain was S.a. Harvard PA14, the culture medium was M63 and the cell inoculation was at 1.5×10⁹ cfu. Biofilm was visualized using the crystal violet method. The data is shown below in Tables 1 and 2:

TABLE 1
(Data for FIG. 11)

| | | | | % Inhibition |
|---|---|---|---|---|
| | | | | relative to |
| | | | | control |
| | Incubation | | | (0%, <50%, |
| Example | Time/ | Active/ | | 50-90%, |
| No. | Temperature | Concentration | Substrate | >90%) |
| Untreated | 24 h/37° C. | 0/0 | Polystyrene | 0 |
| (1 row) | | | | |
| 11.1 | 24 h/37° C. | D-Tyr/100 nM | Polystyrene | 0 |
| 11.2 | 24 h/37° C. | D-Tyr/10 μM | Polystyrene | 0 |
| 11.3 | 24 h/37° C. | D-Tyr/100 μM | Polystyrene | >90% |
| 11.4 | 24 h/37° C. | D-Tyr/500 μM | Polystyrene | >90% |
| 11.5 | 24 h/37° C. | D-Met/100 nM | Polystyrene | 0 |
| 11.6 | 24 h/37° C. | D-Met/10 μM | Polystyrene | 0 |
| 11.7 | 24 h/37° C. | D-Met/100 μM | Polystyrene | 0 |
| 11.8 | 24 h/37° C. | D-Met/500 μM | Polystyrene | 0 |
| 11.9 | 24 h/37° C. | D-Leu/100 nM | Polystyrene | 0 |
| 11.10 | 24 h/37° C. | D-Leu/10 μM | Polystyrene | 0 |
| 11.11 | 24 h/37° C. | D-Leu/100 μM | Polystyrene | 0 |
| 11.12 | 24 h/37° C. | D-Leu/500 μM | Polystyrene | 0 |
| 11.13 | 24 h/37° C. | D-Trp/100 nM | Polystyrene | 0 |
| 11.14 | 24 h/37° C. | D-Trp/10 μM | Polystyrene | 0 |
| 11.15 | 24 h/37° C. | D-Trp/100 μM | Polystyrene | <50% |
| 11.16 | 24 h/37° C. | D-Trp/500 μM | Polystyrene | <50% |
| 11.17 | 24 h/37° C. | D-Met/D-Leu/D- | Polystyrene | >90% |
| | | Trp/D-Tyr mix/ | | |
| | | 100 nM | | |
| 11.18 | 24 h/37° C. | D-Met/D-Leu/D- | Polystyrene | >90% |
| | | Trp/D-Tyr mix/ | | |
| | | 10 μM | | |

TABLE 2
(Data for FIG. 12)

| | | | | % Inhibition |
|---|---|---|---|---|
| | | | | relative to |
| | | | | control |
| | Incubation | | | (0%, <50%, |
| Example | Time/ | Active/ | | 50-90%, |
| No. | Temperature | Concentration | Substrate | >90%) |
| Untreated | 48 h/30° C. | 0/0 | Polystyrene | 0 |
| (1 row) | | | | |
| 12.1 | 48 h/30° C. | D-Trp/100 nM | Polystyrene | 0 |
| 12.2 | 48 h/30° C. | D-Trp/10 μM | Polystyrene | <50% |
| 12.3 | 48 h/30° C. | D-Trp/100 μM | Polystyrene | 50-90% |
| 12.4 | 48 h/30° C. | D-Trp/500 μM | Polystyrene | 50-90% |
| 12.5 | 48 h/30° C. | D-Met/100 nM | Polystyrene | 0 |
| 12.6 | 48 h/30° C. | D-Met/10 μM | Polystyrene | 0 |
| 12.7 | 48 h/30° C. | D-Met/100 μM | Polystyrene | 0 |
| 12.8 | 48 h/30° C. | D-Met/500 μM | Polystyrene | 0 |
| 12.9 | 48 h/30° C. | D-Leu/100 nM | Polystyrene | 0 |
| 12.10 | 48 h/30° C. | D-Leu/10 μM | Polystyrene | 0 |
| 12.11 | 48 h/30° C. | D-Leu/100 μM | Polystyrene | 0 |
| 12.12 | 48 h/30° C. | D-Leu/500 μM | Polystyrene | 0 |
| 12.13 | 48 h/30° C. | D-Tyr/100 nM | Polystyrene | 0 |
| 12.14 | 48 h/30° C. | D-Tyr/10 μM | Polystyrene | >90% |
| 12.15 | 48 h/30° C. | D-Tyr/100 μM | Polystyrene | >90% |
| 12.16 | 48 h/30° C. | D-Tyr/500 μM | Polystyrene | >90% |
| 12.17 | 48 h/30° C. | D-Met/D-Leu/D- | Polystyrene | >90% |
| | | Trp/D-Tyr mix/ | | |
| | | 100 nM | | |
| 12.18 | 48 h/30° C. | D-Met/D-Leu/D- | Polystyrene | >90% |
| | | Trp/D-Tyr mix/ | | |
| | | 10 μM | | |

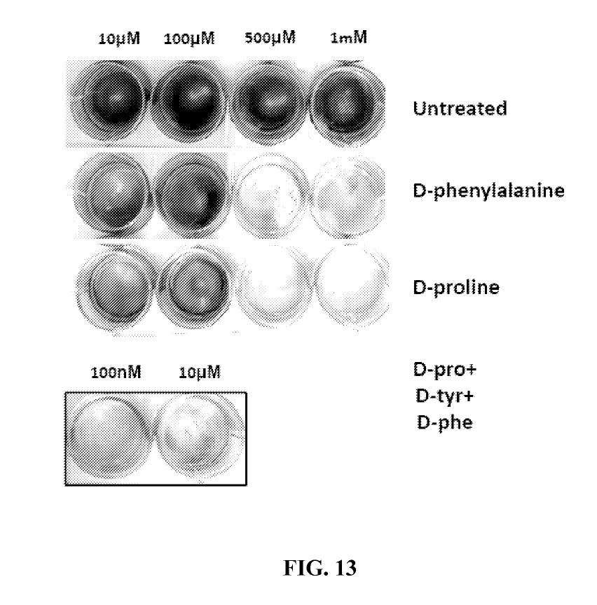

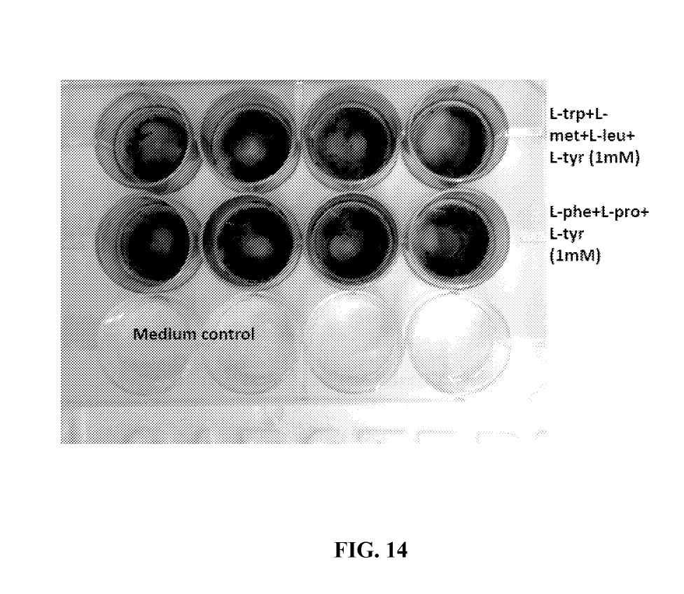

The equimolar mixture of D-tyrosine, D-phenylalanine, D-proline is even more effective than the above mixture. Also, the mixture was more active as a mixture than each of the amino acids individually (FIGS. 13 and 14). For experiments reported in Tables 3 and 4, the organism/strain was S.a. Harvard SCO1, the culture medium was TSB and the cell inoculation was at 2×10⁹ cfu. Biofilm was visualized using the crystal violet method. The data is shown in Tables 3 and 4:

TABLE 3
(Data for FIG. 13)

| | | | | % Inhibition |
|---|---|---|---|---|
| | | | | relative to |
| | | | | control |
| | Incubation | | | (0%, <50%, |
| Example | Time/ | Active/ | | 50-90%, |
| No. | Temperature | Concentration | Substrate | >90%) |
| Untreated | 24 h/37° C. | 0/0 | Polystyrene | 0 |
| (1 row) | | | | |
| 13.1 | 24 h/37° C. | D-Phe/10 μM | Polystyrene | <50% |
| 13.2 | 24 h/37° C. | D-Phe/100 μM | Polystyrene | <50% |
| 13.3 | 24 h/37° C. | D-Phe/500 μM | Polystyrene | >90% |
| 13.4 | 24 h/37° C. | D-Pro/1 mM | Polystyrene | >90% |
| 13.5 | 24 h/37° C. | D-Pro/10 μM | Polystyrene | <50% |
| 13.6 | 24 h/37° C. | D-Pro/100 μM | Polystyrene | <50% |
| 13.7 | 24 h/37° C. | D-Pro/500 μM | Polystyrene | >90% |
| 13.8 | 24 h/37° C. | D-Pro/1 mM | Polystyrene | >90% |
| 13.9 | 24 h/37° C. | D-Pro/D-Phe/D- | Polystyrene | >90% |
| | | Tyr mix/100 nM | | |
| 13.10 | 24 h/37° C. | D-Pro/D-Phe/D- | Polystyrene | >90% |
| | | Tyr mix/10 μM | | |

TABLE 4
(Data for FIG. 14)

| | | | | | % Inhibition |
|---|---|---|---|---|---|
| | | | | | relative to |
| | | | | | control |
| | | Incubation | Active/ | | (0%, <50%, |
| Exam- | Repli- | Time/ | Concen- | | 50-90%, |
| ple No. | cates | Temperature | tration | Substrate | >90%) |
| Medium | 4 | 24 h/37° C. | 0/0 | Polystyrene | 0 |
| control | | | | | |
| 14.1 | 4 | 24 h/37° C. | L-Met/L- | Polystyrene | 0% |
| | | | Leu/L- | | |
| | | | Trp/L- | | |
| | | | Tyr mix/ | | |
| | | | 1 mM | | |
| 14.2 | 4 | 24 h/37° C. | L-Pro/L- | Polystyrene | 0% |
| | | | Phe/L-Tyr | | |
| | | | mix/1 mM | | |

### Example 4

### Alternative Quantification Method for Biofilm Formation in Staphylococcus aureus

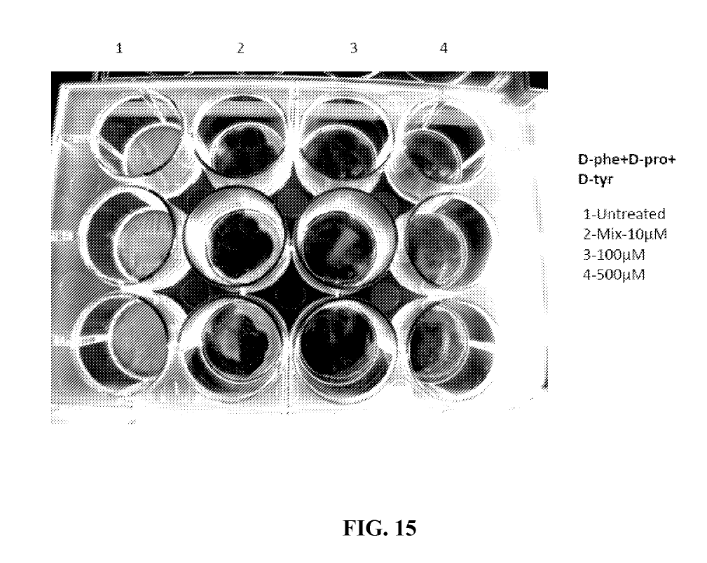

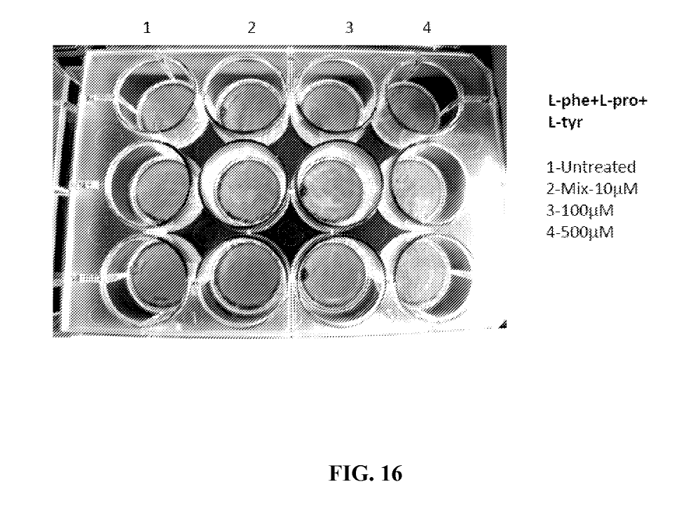

Planktonic cells were completely removed by a Gilson pipette, followed by tapping over a paper towel. Then a photographic image of the biofilm plates was taken carefully against black background (FIGS. 15 and 16). For experiments reported in Tables 5 and 6, the organism/strain was S.a. Harvard SCO1, the culture medium was TSB and the cell inoculation was at 2×10⁹ cfu. Biofilm was visualized using the visual against black background as the method. The data is shown in Tables 5 and 6:

TABLE 5
(Data for FIG. 15)

| | | | | | | % |
|---|---|---|---|---|---|---|
| | | | | | | Inhibition |
| | | | | | | relative to |
| | | | | | | control |
| | | Incubation | | | | (0%, |
| | | Time/ | Active/ | | Visualization | <50%, 50-90%, |
| Example No. | Replicates | Temperature | Concentration | Substrate | Method | >90%) |
| Untreated | 3 | 24 h/37° C. | 0/0 | Polystyrene | Visual | 0 |
| | | | | | against | |
| | | | | | black | |
| | | | | | background | |
| 15.1 | 3 | 24 h/37° C. | D-Pro/D- | Polystyrene | Visual | >90% |
| | | | Phe/D-Tyr | | against | |
| | | | mix/10 μM | | black | |
| | | | | | background | |
| 15.2 | 3 | 24 h/37° C. | D-Pro/D- | Polystyrene | Visual | >90% |
| | | | Phe/D-Tyr | | against | |
| | | | mix/100 μM | | black | |
| | | | | | background | |
| 15.3 | 3 | 24 h/37° C. | D-Pro/D- | Polystyrene | Visual | >90% |
| | | | Phe/D-Tyr | | against | |
| | | | mix/500 μM | | black | |
| | | | | | background | |

TABLE 6
(Data for FIG. 16

| | | | | | | % |
|---|---|---|---|---|---|---|
| | | | | | | Inhibition |
| | | | | | | relative to |
| | | | | | | control |
| | | Incubation | | | | (0%, <50%, |
| Example | | Time/ | Active/ | | Visualization | 50-90%, |
| No. | Replicates | Temperature | Concentration | Substrate | Method | >90%) |
| Untreated | 3 | 24 h/37° C. | 0/0 | Polystyrene | Visual | 0 |
| | | | | | against | |
| | | | | | black | |
| | | | | | background | |
| 16.1 | 3 | 24 h/37° C. | L-Pro/L- | Polystyrene | Visual | 0 |
| | | | Phe/L-Tyr | | against | |
| | | | mix/10 μM | | black | |
| | | | | | background | |
| 16.2 | 3 | 24 h/37° C. | L-Pro/L- | Polystyrene | Visual | 0 |
| | | | Phe/L-Tyr | | against | |
| | | | mix/ | | black | |
| | | | 100 μM | | background | |
| 16.3 | 3 | 24 h/37° C. | L-Pro/L- | Polystyrene | Visual | 0 |
| | | | Phe/L-Tyr | | against | |
| | | | mix/ | | black | |
| | | | 500 μM | | background | |

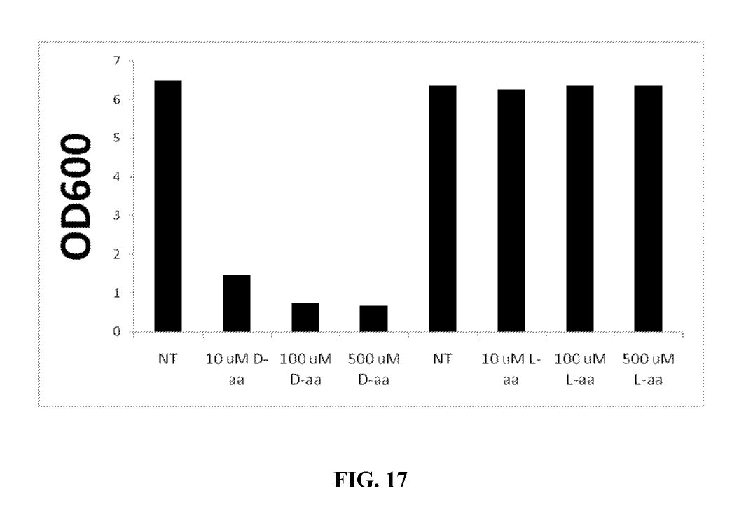

Biofilm cells were removed from the above plates in Tables 5 and 6 by re-suspension in PBS, and their OD600 was determined using spectrophotometer (FIG. 17). For experiments reported in Table 7, the organism/strain was S.a. Harvard SCO1, the culture medium was TSB and the cell inoculation was at 2×10⁹ cfu. Biofilm was visualized by measuring OD600 of absorbed bacteria. The data is shown in Table 7:

TABLE 7
(Data for FIG. 17)

| | Incubation | | | | Measured |
|---|---|---|---|---|---|
| | Time/ | Active/ | | Visualization | Optical |
| Example No. | Temperature | Concentration | Substrate | Method | Density |
| Not Treated | 24 h/37° C. | 0/0 | Polystyrene | Measuring OD₆₀₀ of absorbed bacteria | 6.5 |
| (NT) | | | | | |
| 17.1 | 24 h/37° C. | D-Pro/D- | Polystyrene | ″ | 1.5 |
| | | Phe/D-Tyr mix/ | | | |
| | | 10 μM | | | |
| 17.2 | 24 h/37° C. | D-Pro/D- | Polystyrene | ″ | 0.8 |
| | | Phe/D-Tyr mix/ | | | |
| | | 100 μM | | | |
| 17.3 | 24 h/37° C. | D-Pro/D- | Polystyrene | ″ | 0.7 |
| | | Phe/D-Tyr mix/ | | | |
| | | 500 μM | | | |
| 17.4 | 24 h/37° C. | L-Pro/L- | Polystyrene | ″ | 6.4 |
| | | Phe/L-Tyr mix/ | | | |
| | | 10 μM | | | |
| 17.5 | 24 h/37° C. | L-Pro/L- | Polystyrene | ″ | 6.5 |
| | | Phe/L-Tyr mix/ | | | |
| | | 100 μM | | | |
| 17.6 | 24 h/37° C. | L-Pro/L- | Polystyrene | ″ | 6.5 |
| | | Phe/L-Tyr mix/ | | | |
| | | 500 μM | | | |

### Example 5

### Effect of D-Amino Acids on Staphylococcus aureus Biofilm Formation on Epoxy Surfaces

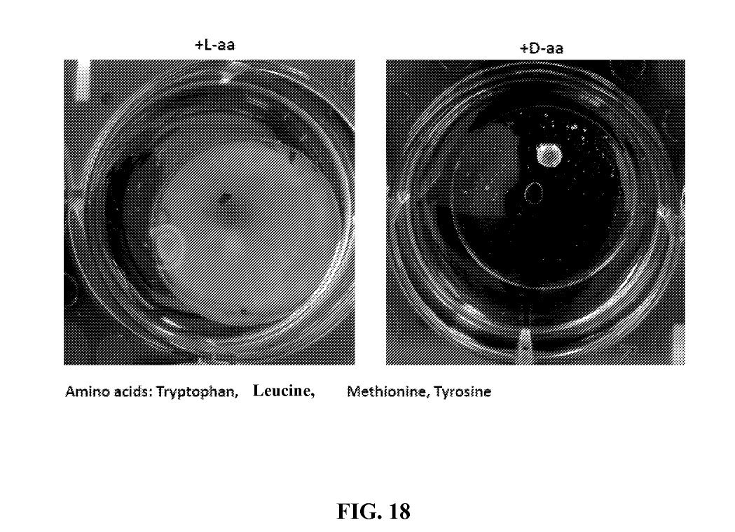

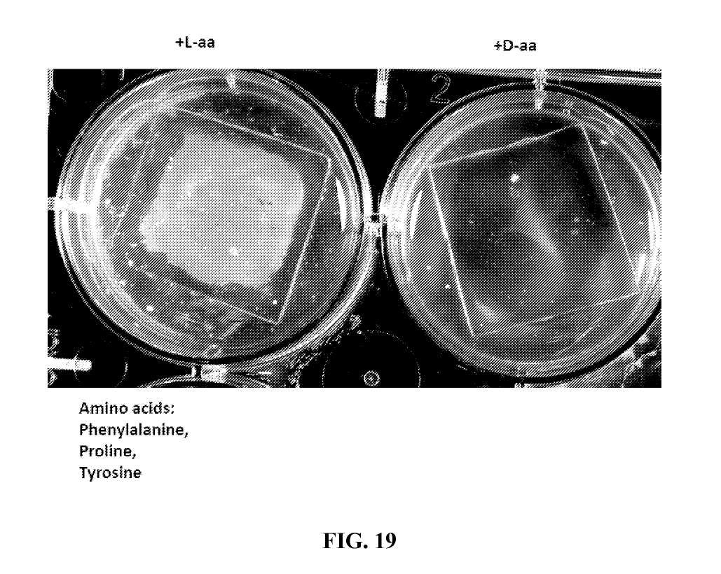

To test the possibility of developing controlled release methods of D-amino acids from different surfaces, epoxy surfaces were incubated for 24 hrs in D-amino acids mixtures. They were completely dried and incubated in a fresh TSB medium inoculated with Staphylococcus aureus. For experiments reported in Tables 8 and 9, the organism/strain was S.a. Harvard SCO1, the culture medium was TSB and the cell inoculation was at 2×109 cfu. Biofilm was visualized using visual against black background. As shown in FIGS. 18 and 19, D-aa mixtures (as described above) dramatically decreased Staphylococcus aureus biofilm formation on the soaked substrates. The data is shown in Tables 8 and 9:

TABLE 8
(Data for FIG. 18)

| | | | | | % Inhibition |
|---|---|---|---|---|---|
| | | | | | relative to |
| | | | | | control |
| | Incubation | | | | (0%, <50%, |
| | Time/ | Active/ | | Visualization | 50-90%, |
| Example No. | Temperature | Concentration | Substrate | Method | >90%) |
| 18.1 | 24 h/37° C. | L-met/Leu/L- | Epoxy | Visual against | 0% |
| | | Trp/L-Tyr mix/ | | black | |
| | | 1 mM | | background | |
| 18.2 | 24 h/37° C. | D-Met/D- | Epoxy | Visual against | >90% |
| | | Leu/D-Trp/D- | | black | |
| | | Tyr mix/1 mM | | background | |

TABLE 9
(Data for FIG. 19)

| | | | | | % Inhibition |
|---|---|---|---|---|---|
| | | | | | relative to |
| | | | | | control |
| | Incubation | | | | (0%, <50%, |
| | Time/ | Active/ | | Visualization | 50-90%, |
| Example No. | Temperature | Concentration | Substrate | Method | >90%) |
| 19.1 | 24 h/37° C. | L-Pro/L- | Epoxy | Visual against | 0% |
| | | Phe/L-Tyr | | black | |
| | | mix/500 μM | | background | |
| 19.2 | 24 h/37° C. | D-Pro/D- | Epoxy | Visual against | >90% |
| | | Phe/D-Tyr mix/ | | black | |
| | | 500 μM | | background | |

Additionally, Norland Optical Adhesive 61 surfaces were incubated with D-tyrosine, D-proline, D-phenylalanine for 24 hrs. They were completely dried and incubated in a fresh TSB medium inoculated with Staphylococcus aureus. The D-aa mixture (but not the L-mixture) dramatically decreased Staphylococcus aureus biofilm formation.

For this example, polymer substrates were molded in polydimethylsiloxane (SYLGARD 184, Dow Corning) from UVO-114 (Epoxy Technology) and Norland Optical Adhesive 61 (Norland Products) UV-curable polymers.

### Example 6

### Additional Ways to Observe D-Amino Acids Effect on Biofilm Formation in Pseudomonas aeruginosa

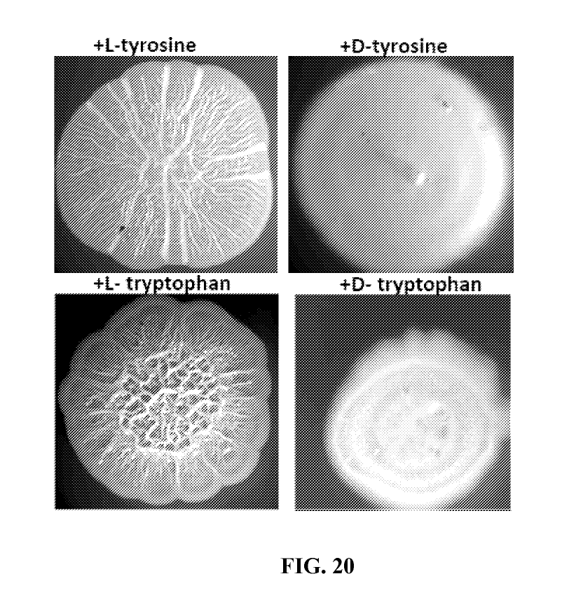

Similarly to Bacillus subtilis, Pseudomonas aeruginosa forms a complex architecture on defined medium. These complex structures require the proper formation and assembly of the extra-cellular matrix. Addition of D-tyrosine (500 μM) or D-tryptophan (500 μM) inhibited biofilm formation on defined medium in Pseudomonas aeruginosa (FIG. 20) while addition of L-tyrosine (500 μM) and L-tryptophan did not. Similar results were obtained with Bacillus subtilis. For these experiments, the organism/strain was P.a. Harvard PA14, the culture medium was M63 and the cell inoculation was at 1.5×10⁹ cfu.

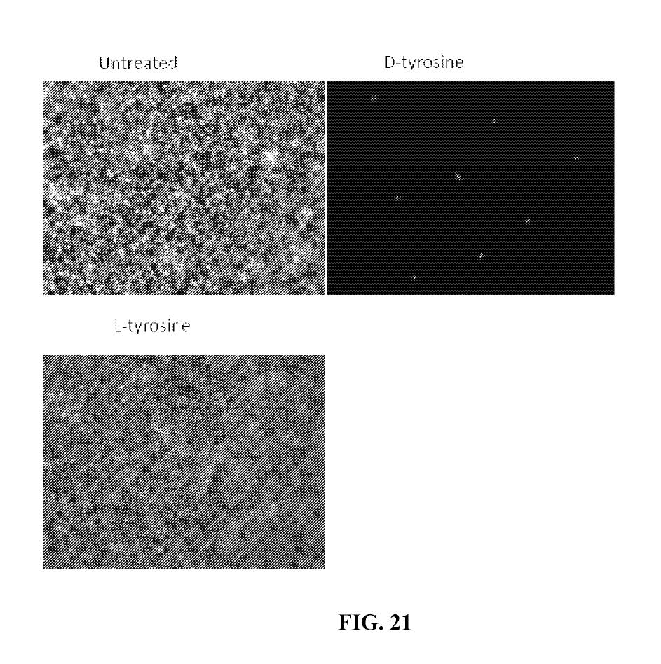

An alternative method to observe biofilm formation on a 6 well plate with or without D-amino acids and using Syto-9 staining was as follows: Pseudomonas aeruginosa biofilms were washed twice with PBS and then fixed for at least an hour in 5% Glutaraldehyde in PBS. The fixed biofilms were then rinsed once again with PBS and soaked in 0.1% v/v Triton X-100 in PBS (PBST) for 15 minutes. The solution was exchanged with 0.1 nM SYTOX green (Invitrogen) in cold PBST and gently rocked in the dark for at least 15 minutes. Fluorescence images of the biofilms were captured with a Leica DMRX compound microscope using a Xe lamp and a K3 Leica filtercube. As shown in FIG. 21, there was a dramatic decrease in the number of cells attached to the bottom of the biofilm plate in the presence of D-tyrosine. The amount of attached single cells was quantified using image J. The decrease in the amount of cells attached to the epoxy surfaces soaked with D-aa compared with the L-aa control was substantially more.

TABLE 10
(Data for FIG. 21)

| | | | | | % Inhibition |
|---|---|---|---|---|---|
| | | | | | relative to |
| | | | | | control |
| | Incubation | | | | (0%, <50%, |
| | Time/ | Active/ | | Visualization | 50-90%, |
| Example No. | Temperature | Concentration | Substrate | Method | >90%) |
| Positive | 12 h/30° C. | 0 | Polystyrene | Syto-9 staining | 0 |
| control | | | | | |
| 21.1 | 12 h/30° C. | D-Tyr/50 μM | Polystyrene | Syto-9 staining | >90% |
| 21.2 | 12 h/30° C. | L-Tyr/500 μM | Polystyrene | Syto-9 staining | 0 |

### Example 7

### Assessing the Effect of D-Amino Acids on a Gram Negative Pathogens

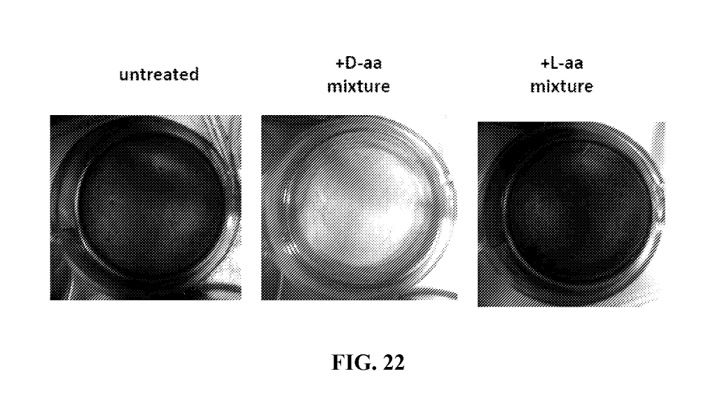

To assess the possibility for a broad-spectrum anti biofilm activity the efficient equimolar quartet of D-tyrosine, D-phenylalanine, and D-proline was tested against the gram negative pathogen Proteus mirabilis. As shown in FIG. 22, the D-aa mixture was active against Proteus mirabilis. Biofilm in Table 11 was visualized using the crystal violet method. The data is shown in Tables 11:

TABLE 11
(Data for FIG. 22)

| | | | | | | | % |
|---|---|---|---|---|---|---|---|
| | | | | | | | Inhibition |
| | | | | | | | relative to |
| | | | | | | | control |
| | | | | Incubation | | | (0%, |
| Example | Organism/ | | Innoculation | Time/ | Active/ | | <50%, 50-90%, |
| No. | Strain | Medium | cfu | Temperature | Concentration | Substrate | >90%) |
| Positive | Proteus | LB | 2+E09 | 48 h/30° C. | 0 | Polystyrene | 0 |
| control | mirabilis. | | | | | | |
| | Harvard | | | | | | |
| 22.1 | Proteus | LB | 2+E09 | 48 h/30° C. | D-Met/D- | Polystyrene | >90% |
| | mirabilis.. | | | | Leu/D-Trp/D- | | |
| | Harvard | | | | Tyr mix/ | | |
| | | | | | 100 μM | | |
| 2 | Proteus | LB | 2+E09 | 48 h/30° C. | L-Met/L- | Polystyrene | 0 |
| | mirabilis. | | | | Leu/L-Trp/L- | | |
| | Harvard | | | | Tyr mix/ | | |
| | | | | | 100 μM | | |

### Example 8

### Assessing the Effect of D-Amino Acids on a Gram Positive Pathogen

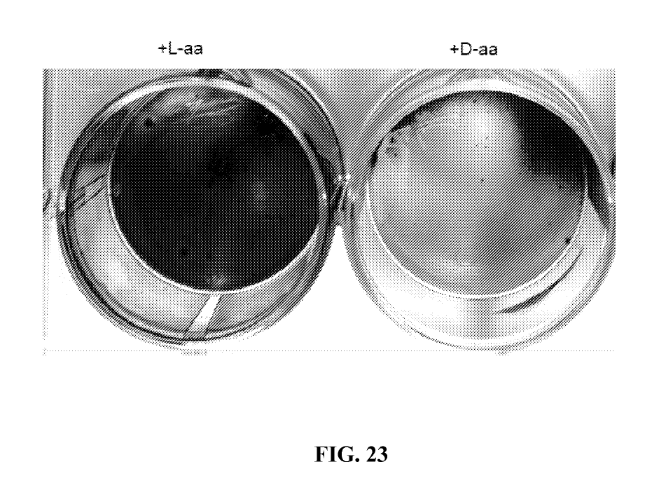

To assess the possibility for a broad-spectrum anti biofilm activity the efficient equimolar quartet of D-tyrosine, D-phenylalanine, and D-proline was tested against the gram positive pathogen Streptococcus mutans. As shown in FIG. 23, the D-aa mixture was active against Streptococcus mutans. Biofilm in Table 12 was visualized using the crystal violet method. The data is shown in Tables 12:

TABLE 12
(Data for FIG. 23)

| | | | | | | | % |
|---|---|---|---|---|---|---|---|
| | | | | | | | Inhibition |
| | | | | | | | relative to |
| | | | | | | | control |
| | | | | Incubation | | | (0%, |
| Example | Organism/ | | Innoculation | Time/ | Active/ | | <50%, 50-90%, |
| No. | Strain | Medium | cfu | Temperature | Concentration | Substrate | >90%) |
| 23.1 | Streptococcus | BHI + | 2+E09 | 72 h/37° C. | L-Met/L- | Polystyrene | 0 |
| | mutans. | sucrose | | | Leu/L-Trp/L- | | |
| | Temple | | | | Tyr mix/1 mM | | |
| 23.2 | Streptococcus | BHI + | 2+E09 | 72 h/37° C. | D-Met/D- | Polystyrene | >90% |
| | mutans. | sucrose | | | Leu/D-Trp/D- | | |
| | Temple | | | | Tyr mix/1 mM | | |

### Example 9

### Coating Containing D-Tyrosine

D-Tyrosine, 0.5%, by weight based on the weight of the resin solids, is incorporated into a two-component polyester urethane coating based on a commercially available polyester polyol and commercially available isocyanurate. The coating system is catalyzed with 0.015% dibutyl tin dilaurate based on total resin solids.

The coating formulation is applied by drawdown onto transparent glass slides approximately 4″×6″ to a film thickness of about 2 mils (0.002″).

These films are cured in an oven at 120° F. (49° C.) oven.

### Example 10

### Polymer Containing D-Amino Acid Mixture

Liquid silicone rubber sheets are prepared as described in U.S. Pat. No. 5,973,030. Further included in the formulations are 0.01 to 1 weight percent D amino acid mixture, in a ratio 1:1:1:1 of D-Tryosine:D-Leucine:D-Methionine:D-Tryptophan.

### Example 11

### Water Based Industrial Coating Containing D-Amino Acid Mixture

Water based clear acrylic industrial coating formulation containing 1 weight percent D amino acid mixture, in a ratio 1:1:1:1 of D-Tyrosine:D-Leucine:D-Methionine:D-Tryptophan is coated onto glass slides at 2 mil thickness.

### Example 12

### Solvent Based Industrial Coating Containing D-Amino Acid Mixture

A solvent based polyurethane coating is prepared containing 1 weight percent D amino acid mixture, in a ratio 1:1:1:1 of D-Tyrosine:D-Leucine:D-Methionine:D-Tryptophan. The coating is applied to glass slides at 2 mil thickness.

### Example 13

### UV Curable Water Based Industrial Coating Containing D-Amino Acid Mixture

A clear UV curable water-borne industrial coating is formulated by mixing with high speed stirrer the ingredients (see table below).

| | Weight-% |
|---|---|
| Alberdingk Lux 399 | 97.8 |
| (acrylate polyurethane copolymer dispersion), | |
| Alberdingk Boley | |
| Borchigel L 75 N (thickener), Borchers | 0.3 |
| Byk 347 (wetting agent), Byk Chemie | 0.4 |
| IRGACURE 500 (photoinitiator), Ciba | 1.0 |
| D-amino acid mixture | 0.5 |

To the prepared formulation, D amino acid mixture, in a ratio 1:1:1:1 of D-Tryosine:D-Leucine:D-Methionine:D-Tryptophan. is added, and stirred at high shear rate (2000 rpm) for 30 minutes at room temperature. For the purpose of comparison, control formulations containing no D amino acids are prepared in the same manner.

The coating is applied with a 50 μm slit coater to white coated aluminum panels, dried 10 minutes at 60° C. and cured with two medium pressure mercury vapor lamps (2×80 W/cm) at 5 m/min.

### Example 14

### Solvent Based Industrial Coating Containing D-Amino Acid Mixture

2 Pack solvent-borne polyurethane coatings are prepared according the following procedure:

D amino acid mixture, in a ratio 1:1:1:1 of D-Tryosine:D-Leucine:D-Methionine:D-Tryptophan is added to the binder and solvent as mill-base formulation and stirred at high shear rate for 10 minutes until a particle size below 5 μm is achieved.

Mill-Base Formulation:

| | Weight-% |
|---|---|
| Macrynal SM 510n (60% acrylic copolymer in 10% aromatic | 88.5 |
| hydrcarbons, 20% xylene, 10% n-butylacetate) | |
| Butylglykolacetate (solvent) | 11.0 |
| D-amino acid mixture | 0.5 |
| Sum | 100.0 |

The coating formulation was prepared by mixing the ingredients of component A and adding component B at the end before application (see table below). The content of the D-amino acid mixture in total formulation is 0.1 wt. %.

| | Weight-% |
|---|---|
| Component A: | |
| Mill-base | 28.0 |
| Macrynal SM 510n (60% acrylic copolymer in 10% aromatic | 52.3 |
| hydrcarbons, 20% xylene, 10% n-butylacetate) | |
| Butylglykolacetate (solvent) | 9.7 |
| Solvesso 100 (mixture of aromatic hydrocarbons) | 6.2 |
| Methylisobutylketone (solvent) | 3.6 |
| Byk 300 (52% solution of a polyether modified | 0.2 |
| dimethylpolysiloxane-copolymer in xylene/isobutanol (4/1)) | |
| Component B: | |
| Desmodur N 75 (75% aliphatic isocyanate in | 40.0 |
| methoxypropylacetate/xylene (1/1)) | |
| Sum | 140.0 |

Each coating formulation is sprayed on white coated aluminum panels (dry film thickness: 40 μm) and dried 30 minutes at 80° C.

### Example 15

### Water in Oil W/O Representative Formulation

The following W/O emulsion is prepared containing 0.1% wt/wt D-amino acid mixture in a ratio 1:1:1:1 of D-Tryosine:D-Leucine:D-Methionine:D-Tryptophan.

### W/O Emulsion:

| | | |
|---|---|---|
| Part A | Paraffin Liquidum | 7.5 parts |
| | Isohexadecane | 6.0 |
| | PEG-7 Hydrogenated | 4.1 |
| | Castor Oil | |
| | Isopropyl Palimitate | 2.0 |
| | Cera microcristallina | 0.5 |
| | Lanolin Alcohol | 0.6 |
| Part B | Water | dil. to 100 parts total formulation |
| | Magnesium Sulfate | 1.0 |
| | Glycine | 3.20 |
| Part C | D-amino acid mixture | 20 parts of 0.5% wt/wt aqueous soln. |

### Example 16

### Oil in Water O/W Representative Formulation

The following 0/W emulsion is prepared containing 0.1% wt/wt D-amino acid mixture in a ratio 1:1:1:1 of D-Tryosine:D-Leucine:D-Methionine:D-Tryptophan.

O/W emulsion:

| | | |
|---|---|---|
| Part A | Steareth-2 | 2.2 parts |
| | Steareth-21 | 1.0 |
| | PEG-15 Stearyl Ether | 6.0 |
| | Dicaprylyl Ether | 6.0 |
| Part B | Water | dil. to 100 parts total formulation |
| | Sodium Polyacrylate | 0.2 |
| Part C | D-amino acid mixture | 20 parts of 0.5% wt/wt aqueous soln. |

### Example 17

### In Vivo Inhibition of S. Aureus Biofilm Formation

In vivo testing of a D-amino acid or a combination of two or more D-amino acids is conducted as described in Anguita-Alonso et al., Antimicrobial Agents and Chemotherapy, 51:2594 (2007).

### Example 18

### Alternative In Vivo Inhibition of S. Aureus Biofilm Formation

In vivo testing of a D-amino acid or a combination of two or more D-amino acids is conducted as described in Beenken et al., J. Bacteriology, 186:4665 (2004).

### Example 19

### Preparation of a Stable Aqueous Mixture of D-Tyr, D-Leu, D-Typ and D-Met

Amino acids D-Met and D-Leu are dissolved individually in deionized water at room temperature using a concentration 5 mg/mL. Typically 10 mL of solution is prepared for each amino acid. D-Tryptophan is dissolved into deionized water at 5 mg/mL, but slight heating is required, 40-50° C. for 5-10 minutes. D-Tyrosine is dissolved at 5 mg/mL in 0.05M HCl and heating is required, 40-50° C. for 5-10 minutes. A heated sonication bath can be used to aid in the solution of the amino acids. All solutions are combined and sterile filtered at room temperature resulting in about 40 mL of stock solution.

### Example 20

### Preparation of a Stable Aqueous Mixture of D-Tyr, D-Pro, and D-Phe

An aqueous solution is prepared as described in Example 19.

### Example 21

### Preparation of a Stable Aqueous Mixture of D-Tyr, D-Asp, and D-Glu

An aqueous solution is prepared as described in Example 19.

### Example 22

### Preparation of a Stable Aqueous Mixture of D-Tyr, D-Arg, D-His, and D-Lys

An aqueous solution is prepared as described in Example 19.

### Example 23

### Preparation of a Stable Aqueous Mixture of D-Tyr, D-Ile, D-Val- and D-Asn

An aqueous solution is prepared as described in Example 19.

### Example 24

### Preparation of a Stable Aqueous Mixture of D-Tyr, D-Cys, D-Ser, D-Thr and D-Gln

An aqueous solution is prepared as described in Example 19.

### EQUIVALENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A method of treating, reducing, or inhibiting biofilm formation by bacteria, the method comprising:
contacting an article with a composition comprising an effective amount of a D-amino acid, said composition being essentially free of the corresponding L-amino acid, thereby treating, reducing or inhibiting formation of the biofilm,
wherein the D-amino acid is selected from the group consisting of D-alanine, D-cysteine, D-aspartic acid, D-glutamic acid, D-histidine, D-isoleucine, D-lysine, D-leucine, D-asparagine, D-proline, D-glutamine, D-arginine, D-serine, D-threonine, D-valine, D-tryptophan, D-tyrosine, and a combination thereof.

2. A method of treating, reducing, or inhibiting biofilm formation by bacteria, the method comprising:
contacting an article with a composition comprising an effective amount of a combination of D-amino acids, thereby treating, reducing or inhibiting formation of the biofilm.

3. The method of claim 2,
wherein the combination of D-amino acids is a combination of two or more D-amino acids selected from the group consisting of D-alanine, D-cysteine, D-aspartic acid, D-glutamic acid, D-phenylalanine, D-histidine, D-isoleucine, D-lysine, D-leucine, D-methionine, D-asparagine, D-proline, D-glutamine, D-arginine, D-serine, D-threonine, D-valine, D-tryptophan, and D-tyrosine.

4. The method of any of claim 1, 2 or 3, wherein the article is one or more selected from the group consisting of comprises a industrial equipment, plumbing systems, bodies of water, household surfaces, textiles and paper.

5. The method of any of claim 1, 2 or 3, wherein the article is one or more components involved in water condensate collection, water recirculation, sewerage transport, paper pulping and manufacture, and water processing and transport.

6. The method of any of claim 1, 2 or 3, wherein the article is a drain, tub, kitchen appliance, countertop, shower curtain, grout, toilet, industrial food or beverage production facility, floor, boat, pier, oil platform, water intake port, sieve, water pipe, cooling system, or powerplant.

7. The method of any of claim 1, 2 or 3, wherein the article is made from a material selected from the group consisting of metal, metal alloy, synthetic polymer, natural polymer, ceramic, wood, glass, leather, paper, fabric, nom-metallic inorganics, composite materials and combinations thereof.

8. The method of any of claims 1-7, wherein contacting comprises applying a coating to the article, said coating comprising an effective amount of the D-amino acid.

9. The method of claim 8, wherein the coating further comprises a binder.

10. The method of claim 8, wherein coating is accomplished by wicking, spraying, dipping, spin coating, laminating, painting, screening, extruding or drawing down a coating composition onto the surface.

11. The method of any of claims 1-7, wherein contacting comprises introducing a D-amino acid into a precursor material and processing the precursor material into the article impregnated with D-amino acid.

12. The method of any of claims 1-8, wherein contacting comprising introducing a D-amino acid into a liquid composition.

13. The method of any one of the preceding claims, wherein the composition comprises D-tyrosine.

14. The method of claim 13, wherein the composition further comprises one or more of D-proline and D-phenylalanine.

15. The method of claim 13, wherein the composition further comprises one or more of D-leucine, D-tryptophan, and D-methionine.

16. The method of claim 13, wherein the composition further comprises one or more of D-alanine, D-cysteine, D-aspartic acid, D-glutamic acid, D-phenylalanine, D-histidine, D-isoleucine, D-lysine, D-leucine, D-methionine, D-asparagine, D-proline, D-glutamine, D-arginine, D-serine, D-threonine, D-valine, D-tryptophan, D-tyrosine.utamic acid, D-phenylalanine, D-histidine, D-isoleucine, D-lysine, D-leucine, D-asparagine, D-proline, D-glutamine, D-arginine, D-serine, D-threonine, D-valine, and D-tryptophan.

17. The method of claim 13, wherein the composition comprises D-tyrosine, D-proline and D-phenylanaline.

18. The method of claim 13, wherein the composition comprises D-tyrosine, D-leucine, D-trytophan and D-methionine.

19. The method of any one of the preceding claims, further comprising contacting the surface with a biocide.

20. The method of any one of the preceding claims, wherein the composition contains less than 1% L-amino acids.

21. The method of any one of the preceding claims, wherein the composition is essentially free of detergent.

22. The method of claim 19, wherein the composition comprises polyhexamethylene biguanide, chlorhexidine, xylitol, triclosan, or chlorine dioxide.

23. A coated article resistant to biofilm formation, comprising:
an article comprising a coating on at least one exposed surface, the coating comprising an effective amount of a D-amino acid and being essentially free of the corresponding L-amino acid, thereby treating, reducing or inhibiting formation of the biofilm,
wherein the D-amino acid is selected from the group consisting of D-alanine, D-cysteine, D-aspartic acid, D-glutamic acid, D-histidine, D-isoleucine, D-lysine, D-leucine, D-asparagine, D-proline, D-glutamine, D-arginine, D-serine, D-threonine, D-valine, D-tryptophan, D-tyrosine, and a combination thereof.

24. A coated article resistant to biofilm formation, comprising:
an article comprising a coating on at least one exposed surface, the coating comprising an effective amount of a combination of D-amino acids, thereby treating, reducing or inhibiting formation of the biofilm.

25. The coated article of claim 24,
wherein the combination of D-amino acids is a combination of two or more D-amino acids selected from the group consisting of D-alanine, D-cysteine, D-aspartic acid, D-glutamic acid, D-phenylalanine, D-histidine, D-isoleucine, D-lysine, D-leucine, D-methionine, D-asparagine, D-proline, D-glutamine, D-arginine, D-serine, D-threonine, D-valine, D-tryptophan, and D-tyrosine.

26. The coated article of any of claim 23, 24 or 25, wherein the article is one or more selected from the group consisting of comprises a industrial equipment, plumbing systems, bodies of water, household surfaces, textiles and paper.

27. The coated article of any of claim 23, 24 or 25, wherein the article is one or more components involved in water condensate collection, water recirculation, sewerage transport, paper pulping and manufacture, and water processing and transport.

28. The coated article of any of claim 23, 24 or 25, wherein the article is a drain, tub, kitchen appliance, countertop, shower curtain, grout, toilet, industrial food or beverage production facility, floor, boat, pier, oil platform, water intake port, sieve, water pipe, cooling system, or powerplant.

29. The coated article of any of claim 23, 24 or 25, wherein the article is made from a material selected from the group consisting of metal, metal alloy, synthetic polymer, natural polymer, ceramic, wood, glass, leather, paper, fabric, nom-metallic inorganics, composite materials and combinations thereof.

30. The coated article of any of claims 23 through 29, wherein the coating further comprises a binder.

31. The coated article of any of claims 23 through 30, wherein the coating further comprises a polymer and the D-amino acid is distributed in the polymer.

32. The coated article of any of claims 23 through 31, wherein the D-amino acid coating is formulated as a slow-release formulation.

33. The coated article or composition of any of claims 23 through 32, wherein the composition comprises D-tyrosine.

34. The coated article or composition of claim 34, wherein the composition further comprises one or more of D-proline and D-phenylalanine.

35. The coated article or composition of claim 34, wherein the composition further comprises one or more of D-leucine, D-tryptophan, and D-methionine.

36. The coated article or composition of claim 34, wherein the composition further comprises one or more of D-alanine, D-cysteine, D-aspartic acid, D-glutamic acid, D-phenylalanine, D-histidine, D-isoleucine, D-lysine, D-leucine, D-methionine, D-asparagine, D-proline, D-glutamine, D-arginine, D-serine, D-threonine, D-valine, D-tryptophan, D-tyrosine.utamic acid, D-phenylalanine, D-histidine, D-isoleucine, D-lysine, D-leucine, D-asparagine, D-proline, D-glutamine, D-arginine, D-serine, D-threonine, D-valine, and D-tryptophan.

37. The coated article or composition of claim 34, wherein the composition comprises D-tyrosine, D-proline and D-phenylanaline.

38. The coated article or composition of claim 34, wherein the composition comprises D-tyrosine, D-leucine, D-trytophan and D-methionine.

39. The coated article or composition of any of claims 23 through 38, further comprising a biocide.

40. The coated article or composition of claim 39, wherein the biocide comprises polyhexamethylene biguanide, chlorhexidine, xylitol, triclosan, or chlorine dioxide.

41. The coated article or composition of any of claims 23 through 40, wherein the composition is essentially free of detergent.

42. A composition resistant to biofilm formation, comprising:
a fluid base; and
an effective amount of a D-amino acid distributed in the base, thereby treating, reducing or inhibiting formation of the biofilm,
wherein the composition is essentially free of the corresponding L-amino acid, and
wherein the D-amino acid is selected from the group consisting of D-alanine, D-cysteine, D-aspartic acid, D-glutamic acid, D-histidine, D-isoleucine, D-lysine, D-leucine, D-asparagine, D-proline, D-glutamine, D-arginine, D-serine, D-threonine, D-valine, D-tryptophan, D-tyrosine, and a combination thereof.

43. A composition resistant to biofilm formation, comprising:
a fluid base; and
an effective amount of a combination of D-amino acids distributed in the base, thereby treating, reducing or inhibiting formation of the biofilm,
wherein the combination of D-amino acids is a combination of two or more D-amino acids selected from the group consisting of D-alanine, D-cysteine, D-aspartic acid, D-glutamic acid, D-phenylalanine, D-histidine, D-isoleucine, D-lysine, D-leucine, D-methionine, D-asparagine, D-proline, D-glutamine, D-arginine, D-serine, D-threonine, D-valine, D-tryptophan, and D-tyrosine.

44. The composition of claim 42 or 43, wherein the fluid base is selected from a liquid, gel, paste.

45. The composition of claim 42 or 43, wherein the composition is selected from the group consisting of water, washing formulations, disinfecting formulations, paints and coating formulations.

46. A coating composition comprising
two or more D-amino acids, wherein at least one D-amino acid is selected from the group consisting of D-tyrosine, D-leucine, D-methionine, and D-tryptophan, and at least one D-amino acid is a different D-amino acid selected from the group consisting of D-cysteine, D-aspartic acid, D-glutamic acid, D-phenylalanine, D-histidine, D-isoleucine, D-lysine, D-leucine, D-methionine, D-asparagine, D-proline, D-glutamine, D-arginine, D-serine, D-threonine, D-valine, D-tryptophan, and D-tyrosine; and
a polymeric binder.

47. An article, comprising
at least one component comprising an effective amount of a D-amino acids, wherein at least one D-amino acid is selected from the group consisting of D-tyrosine, D-leucine, D-methionine, and D-tryptophan, and at least one D-amino acid is a different D-amino acid selected from the group consisting of D-cysteine, D-aspartic acid, D-glutamic acid, D-phenylalanine, D-histidine, D-isoleucine, D-lysine, D-leucine, D-methionine, D-asparagine, D-proline, D-glutamine, D-arginine, D-serine, D-threonine, D-valine, D-tryptophan, and D-tyrosine, wherein the composition is essentially free of the corresponding L-amino acid, said D-amino acid embedded in the component.
